(19) United States
(12) Patent Application Publication
(10) Pub. No.: US 2004/0246991 A1
(43) Pub. Date: Dec. 9, 2004

(54) IP address translator and packet transfer apparatus

(75) Inventors: Akihito Tsuzuki, Yokohama (JP); Noriyuki Sueyoshi, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi Communication Technologies, Ltd., Tokyo (JP)

(21) Appl. No.: 10/646,550

(22) Filed: Aug. 22, 2003

(30) Foreign Application Priority Data
Jun. 6, 2003 (JP) 2003-162392

(51) Int. Cl. H04J 3/16

(52) U.S. Cl. 370/466

(57) ABSTRACT

An IP address translator comprising: SIP-ALG message processing unit for assigning a virtual IP address in a process of establishing a session between an IPv4 apparatus and an IPv6 apparatus via a SIP server; an address translation table for storing a relation between an IPv4 address and a virtual IPv6 address, a relation between an IPv6 address and a virtual IPv4 address, and filter information in association with each of the virtual addresses; and a processor for performing address translation on the IPv4 and IPv6 packets according to the address translation table, wherein header information of received packets is checked on the basis of the filter information before the address translation to discard a packet which does not adapt to the filter information.

### BACKGROUND OF THE INVENTION

(1) Field of the Invention

The present invention relates to an IP address translator and a packet transfer apparatus and, more particularly, to an IP address translator and a packet transfer apparatus which are effective for packet communication performed via a virtual communication path (session) between two terminals connected to IP networks of different address systems.

(2) Description of the Related Art

With rapid spread of the IP (Internet Protocol) network, address shortage occurs in an IPv4 (Internet Protocol version 4) network using a 32-bit address. Consequently, a new communication protocol IPv6 (Internet Protocol version 6) using a 128-bit address has been proposed. In the case where a communication is performed between a communication apparatus connected to an IPv4 network (hereinafter, called an IPv4 terminal) and a communication apparatus connected to an IPv6 network (hereinafter, called an IPv6 terminal), it is necessary to perform translation between an IPv4 address and an IPv6 address and rewrite an IP header by a connection node between the IPv4 network and the IPv6 network. In the specification, an apparatus having the function of translation from an IPv4 address to an IPv6 address (or translation from an IPv6 address to an IPv4 address) including header conversion will be called an IP address translator.

In the case where communication is performed between an IPv4 terminal having an IPv4 address x and an IPv6 terminal having an IPv6 address y, prior to communication, a virtual IPv6 address X is assigned to the IPv4 terminal and a virtual IPv4 address Y is assigned to the IPv6 terminal. The IPv4 terminal transmits an IPv4 packet designating the destination terminal by the virtual IPv4 address Y, and the IPv6 terminal transmits an IPv6 packet designating the destination terminal by the virtual IPv6 address X. In this case, the IP address translator has to pre-store the corresponding relation between the addresses x and X and the corresponding relation between the addresses y and Y. When an IPv4 packet having the addresses x and Y is received from the IPv4 network, the IP address translator translates the IPv4 packet into an IPv6 packet having the addresses X and y and transfers the IPv6 packet to the IPv6 network. On the contrary, when an IPv6 packet having the addresses X and y is received from the IPv6 network, the IP address translator translates the IPv6 packet into an IPv4 packet having the addresses x and Y and transfers the IPv4 packet to the IPv4 network.

As a conventional technique regarding IP address translation, In Japanese Unexamined Patent Publication No. 11-136285 (Patent Document 1), for example, when an IPv4 terminal inquires an address translator of an IPv6 address by designating the domain name of a destination IPv6 terminal, the address translator obtains the IPv6 address of the destination terminal from a DNS (Domain Name System) server of an IPv6 network, dynamically acquires a virtual IPv4 address corresponding to the IPv6 address from a DHCP (Dynamic Host Configuration Protocol) server, and notifies the IPv4 terminal as a requester of the virtual IPv4 address.

When the IPv4 terminal transmits an IPv4 packet using the virtual IPv4 address as a destination address, the address translator translates the source IPv4 address to a virtual IPv6 address by adding fixed data to the source IPv4 address, and retrieves an IPv6 address corresponding to the destination virtual IPv4 address from an address translation table, thereby translating the destination IPv4 address into the IPv6 address.

In order to deal with shortage of virtual IPv4 addresses, Japanese Unexamined Patent Publication No. 2001-285366 (Patent Document 2) proposes a technique that an address translator, which receives an inquiry of an IPv4 address of the other party IPv6 terminal from an IPv4 terminal, assigns a virtual IPv4 address to a combination of the IPv6 terminal and the IPv4 terminal, thereby sharing the same virtual IPv4 address by a plurality of IPv6 terminals.

In the case of receiving, for example, an IPv4 packet after the virtual IPv4 address is assigned, the address translator retrieves an IPv6 address of the destination terminal from an address translation table by using the combination between the source IPv4 address and the destination virtual IPv4 address of the received packet as a search key. The source IPv4 address is translated into a source virtual IPv6 address in accordance with a predetermined rule in a manner similar to Patent Document 1.

On the other hand, in the field of the IP network, a VoIP (Voice over IP) technique of transmitting voice by IP packets is known. In the VoIP, a virtual communication path or session is established between terminals in advance of communication, and IP packets including voice data are transferred over the communication path. The session between the terminals is established and disconnected in accordance with a session control protocol.

The IETF (Internet Engineering Task Force) made specifications of SIP (Session Initiation Protocol) adapted to VoIP as a session control protocol in an IP multimedia communication (IETF RFC3261: Non-Patent Document 1). The SIP is an application protocol using a transport mechanism such as TCP (Transmission Control Protocol) or UDP (User Datagram Protocol). The SIP is a protocol of a text base, and a SIP message is constructed by a header portion for carrying request or response information and a message body in which the details of the session are described. For description of the session, for example, SDP (Session Description Protocol) is applied and the other party is identified by using a SIP URI (Uniform Resource Identifier).

As operation modes of a SIP server, there are a proxy mode in which a session establishment (call set up) request between terminals is transferred via a SIP server, and a redirect mode in which an originating-side terminal obtains information of a terminating-side terminal from a SIP server and performs communication directly with the terminating-side terminal.

In the case where an IPv4 terminal performs communication with an IPv6 terminal by using a session control protocol typified by the SIP, the IPv4 terminal transmits an IP control packet including a SIP call set up request message (INVITE) designating the terminating-side IPv6 terminal by URI to a SIP server (IPv4 SIP server) connected to the IPv4 network. The IPv4 SIP server rewrites the destination address of the IP packet and transfers the resultant IP packet to a terminating-side SIP server (IPv6 SIP server) connected to an IPv6 network. The IPv6 SIP server specifies the IPv6 address of the terminating-side IPv6 terminal on the basis of the URI indicated in the received message, rewrites the destination address, and transfers the resultant IP packet to the terminating-side IPv6 terminal. In this case, the IPv4 SIP server and the IPv6 SIP server obtain, as necessary, the IP address of the packet transfer destination from a DNS server. The IPv6 terminal having received the INVITE message transmits an IP control packet including a SIP response message (200 OK) to the IPv6 SIP server. The IP packet is transferred to the originating-side IPv4 terminal in the direction opposite to a transfer sequence of the INVITE message.

### SUMMARY OF THE INVENTION

In a packet communication using the session control protocol, an address translator has to execute IP address translation between the address of the IPv4 SIP server and the address of an IPv6 SIP server indicated in an IP control packet, in a session establishing process. In this case, the address translator does not accept an inquiry of the IP address of a destination terminal from the originating-side terminal unlike Patent Documents 1 and 2. Further, each of the IPv4 SIP server and the IPv6 SIP server does not have a function of communication processing for assigning virtual IP addresses to originating-side and terminating-side terminals.

It is, therefore, an issue how to assign respective virtual IP addresses to the originating-side and terminating-side terminals and how to notify each terminal of the virtual IP address of the other party. It is also an issue how to set address translation control information necessary for translation of the IP addresses of data packets communicated between terminals into an address translator.

An object of the invention is to provide an IP address translator and a packet transfer apparatus effective to a case where packet communication is performed via a virtual communication path (session) between terminals of different protocol versions.

Another object of the invention is to provide an IP address translator and a packet transfer apparatus for achieving communication between terminals of different protocol versions while discarding data packets illegally using a destination address.

To achieve the objects, an IP address translator according to the invention comprises: means for assigning, in a process of establishing a session between an IPv4 apparatus having an IPv4 address and an IPv6 apparatus having an IPv6 address, a virtual IPv6 address to the IPv4 apparatus and a virtual IPv4 address to the IPv6 apparatus; an address translation table for storing a correspondence relation between the IPv4 address and the virtual IPv6 address, a correspondence relation between the IPv6 address and the virtual IPv4 address, and filter information in association with each of the virtual addresses; and address translation processor for translating IP addresses of a data packet received from the IPv4 apparatus or the IPv6 apparatus in accordance with the address translation table, wherein the address translation processor checks header information of each of data packets to be subjected to address translation on the basis of the filter information stored in the address translation table, discards a data packet which does not adapt to the filter information, and executes address translation on a data packet which adapts to the filter information.

The invention provides an IP address translator comprising: session control packet processing means for capturing a session control packet communicated between an IPv4 apparatus having an IPv4 address and an IPv6 apparatus having an IPv6 address, transferring the session control packet to a payload converter in a form of an encapsulated packet, translating when an encapsulated packet including a session control packet having been subjected to payload conversion is received from the payload converter, IP addresses of the session control packet extracted from the encapsulated packet, and transferring the resultant packet to a destination network; address information managing means for assigning, in response to a request from the payload converter, a virtual IPv6 address or a virtual IPv4 address to an IPv4 address or an IPv6 address, storing address translation information indicative of a relation between the IPv4 address and the virtual IPv6 address and address translation information indicative of a relation between the IPv6 address and the virtual IPv4 address in association with filter information designated by the payload converter into the address translation table, and notifying the payload converter of the results of the virtual address assignment; and address translation means for translating an IP address of a data packet received from the IPv4 apparatus or the IPv6 apparatus in accordance with the address translation table, wherein the address translation means checks header information of each of data packets to be subjected to address translation on the basis of the filter information stored in the address translation table, discards a data packet which does not adapt to the filter information, and executes address translation on a data packet which adapts to the filter information.

In the invention, the filter information in association with the virtual IPv4 address specifies, for example, a source IPv6 address and a port number to be used in a data packet having the virtual IPv4 address as a destination address, and filter information in association with the virtual IPv6 address specifies a source IPv4 address and a port number to be used in a data packet having the virtual IPv6 address as a destination address.

A packet transfer apparatus according to the invention is comprised of a plurality of line interfaces, a plurality of protocol processing units each provided for each of the line interfaces, and a switching unit for switching packets among the plurality of protocol processing units, wherein one of the line interfaces is connected to a payload converter, and at least one of the protocol processing units which is accompanying a line interface connected to an IPv4 network or an IPv6 network has the function of the above-described IP address translator.

The other objects and features of the invention will become apparent from the following description of embodiments.

### BRIEF DESCRIPTION OF THE INVENTION

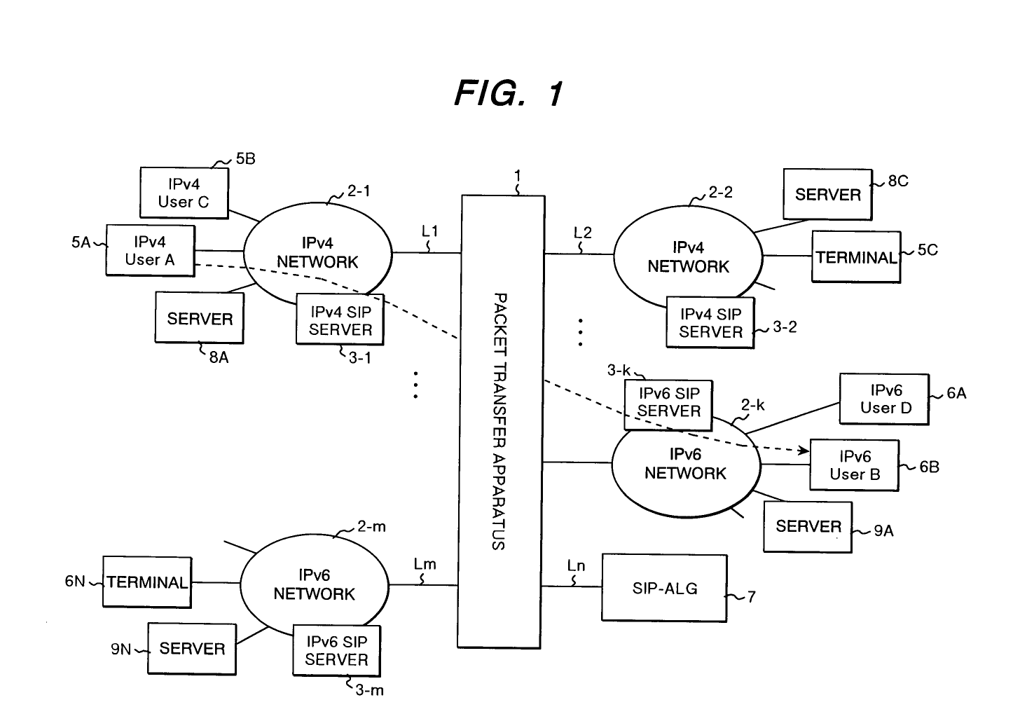

FIG. 1 is a diagram showing an example of a communication network to which an address translator of the invention is applied.

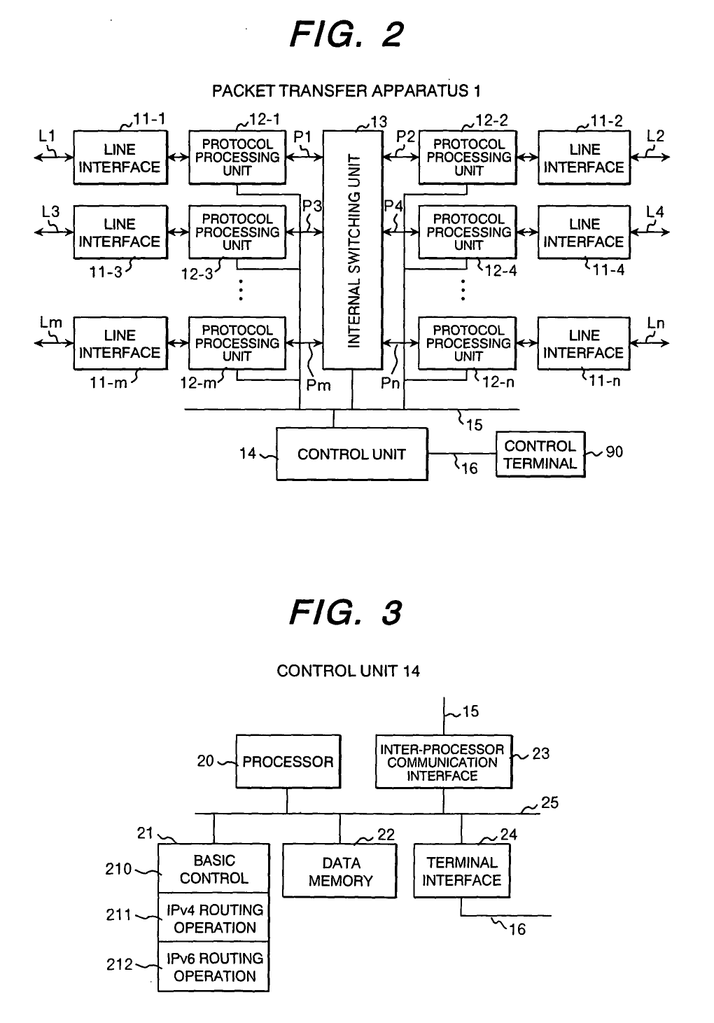

FIG. 2 is a diagram showing an example of the configuration of a packet transfer apparatus 1.

FIG. 3 is a diagram showing an example of the configuration of a control unit 14 in FIG. 2.

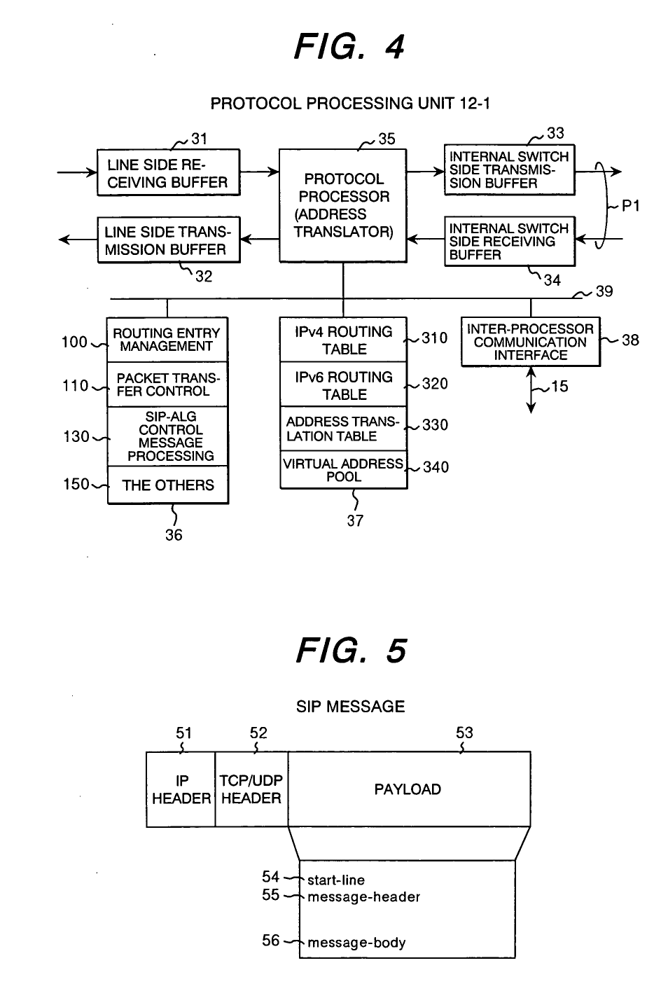

FIG. 4 is a diagram showing an example of the configuration of a protocol processing unit 12-1 in FIG. 2.

FIG. 5 is a diagram showing a packet format of a SIP message.

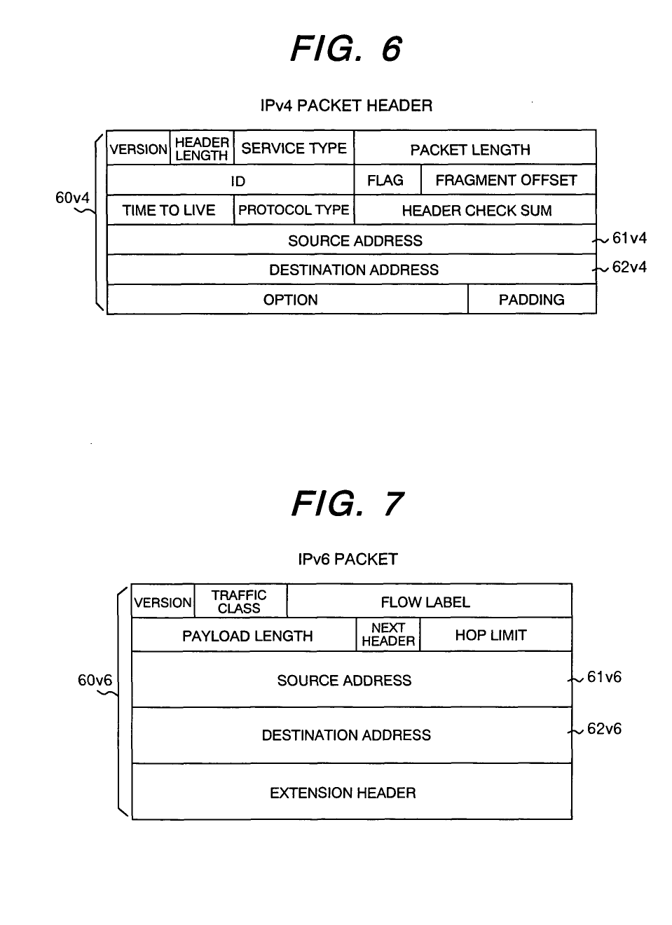

FIG. 6 is a diagram showing a header format of an IPv4 packet.

FIG. 7 is a diagram showing a header format of an IPv6 packet.

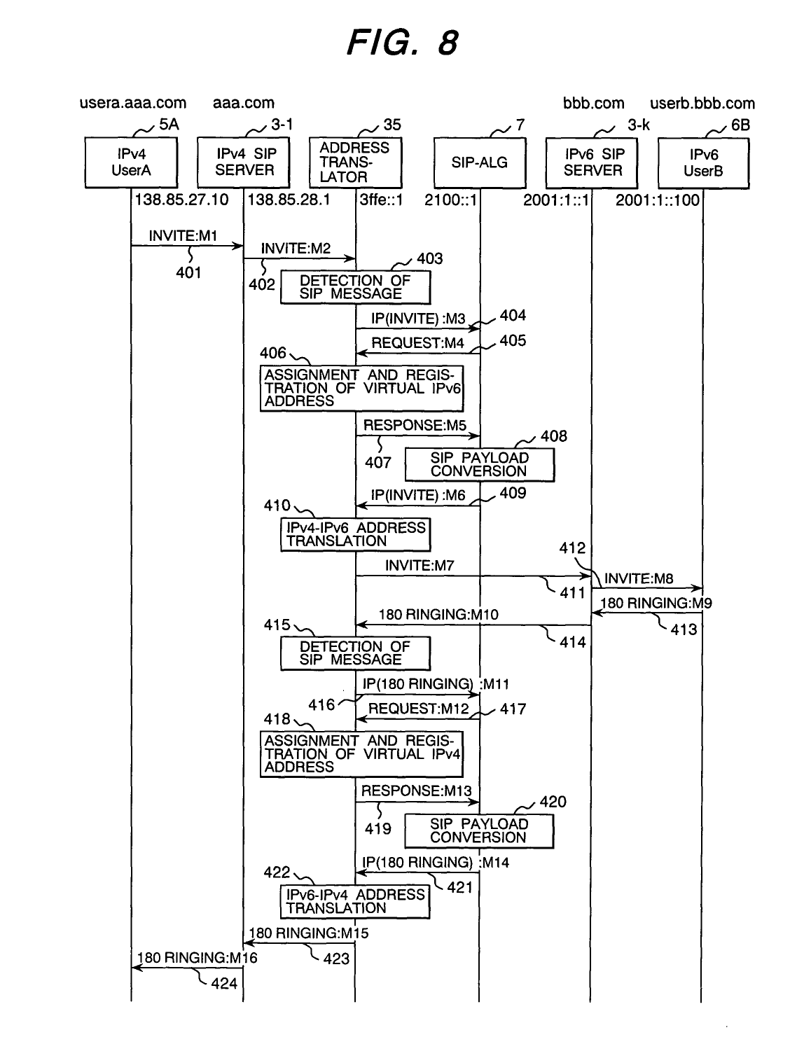

FIG. 8 is a diagram showing a part of a session establishing sequence between an IPv4 terminal 5A and an IPv6 terminal 6B in the communication network of FIG. 1.

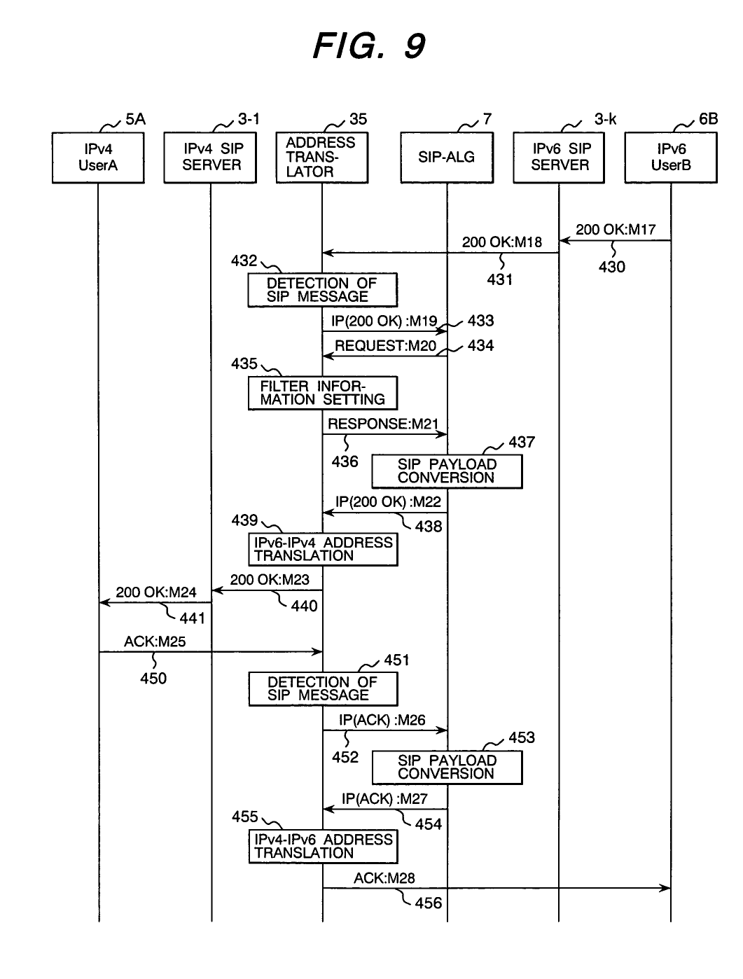

FIG. 9 is a diagram showing the remaining part of the session establishing sequence.

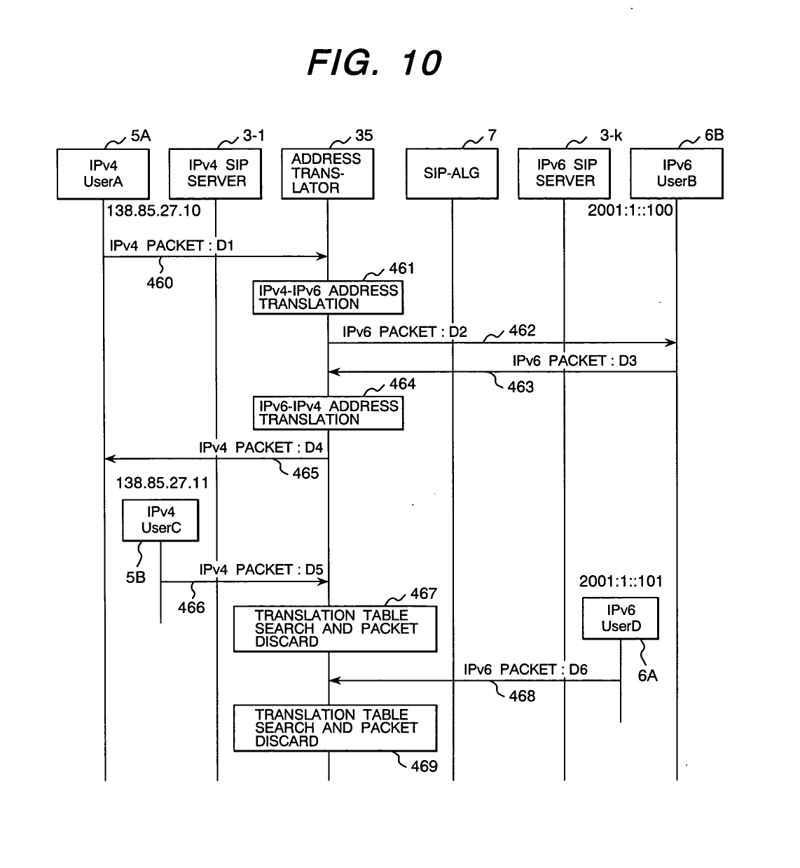

FIG. 10 is a diagram showing a sequence of transferring data packets by an address translator (protocol processor) 35.

FIG. 11 is a diagram showing a sequence of disconnecting the session between the IPv4 terminal 5A and the IPv6 terminal 6B.

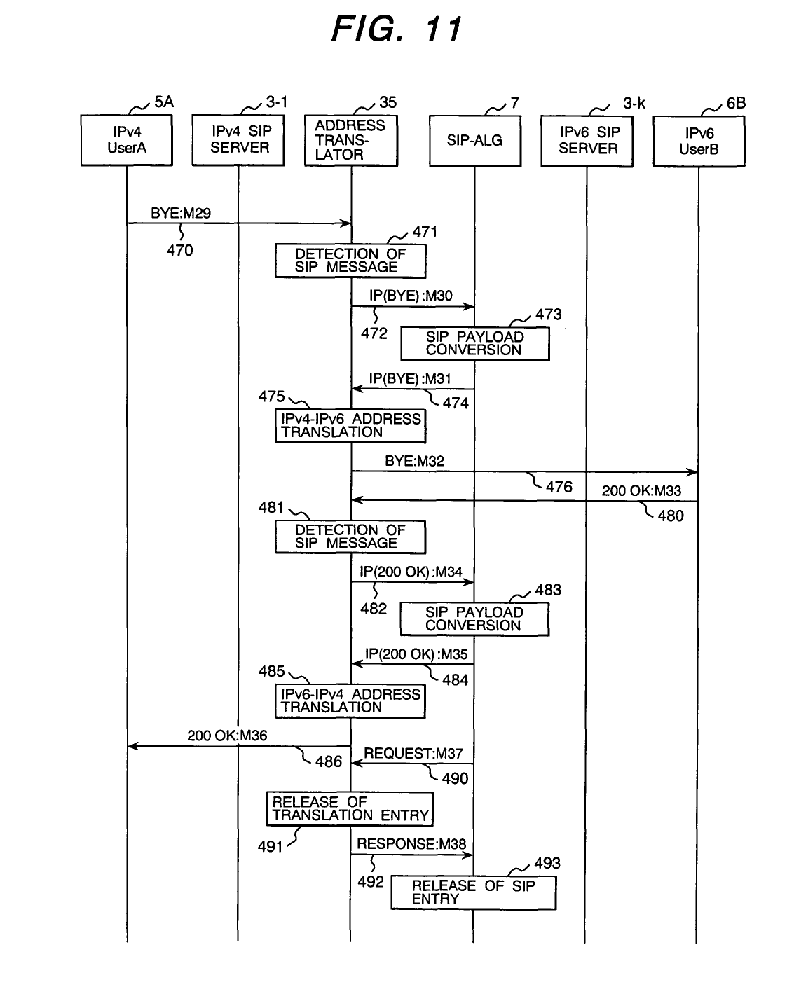

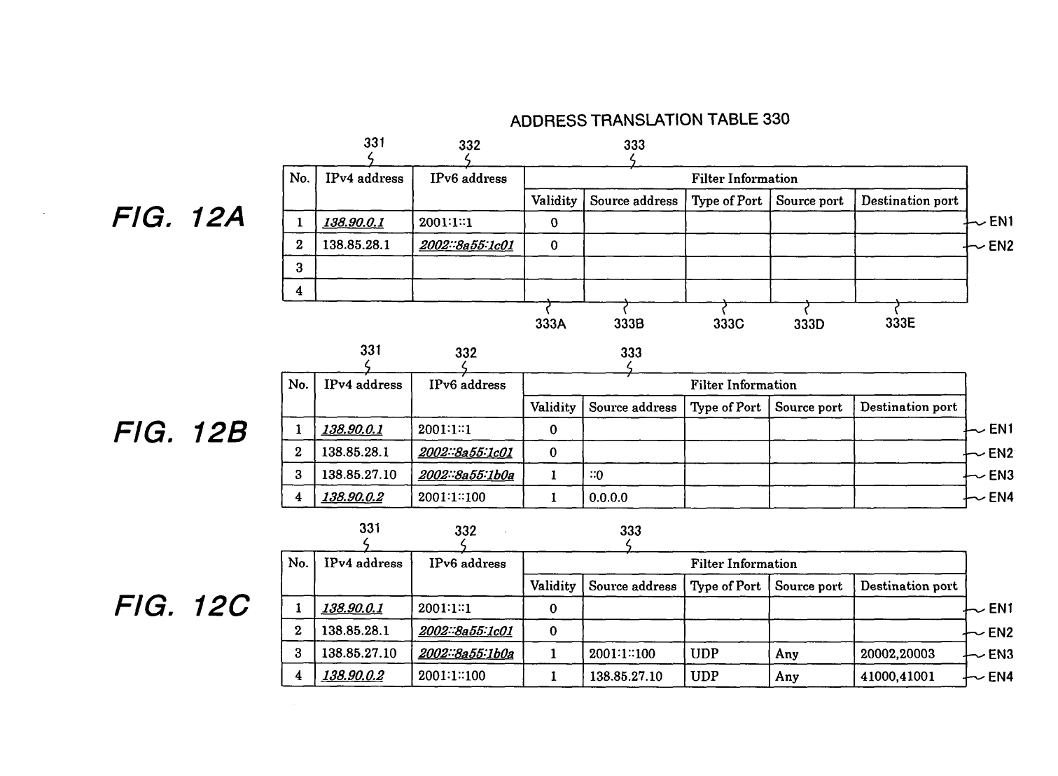

FIGS. 12A to 12C are diagrams each showing the contents of an address translation table 330 of the address translator (protocol processor) 35.

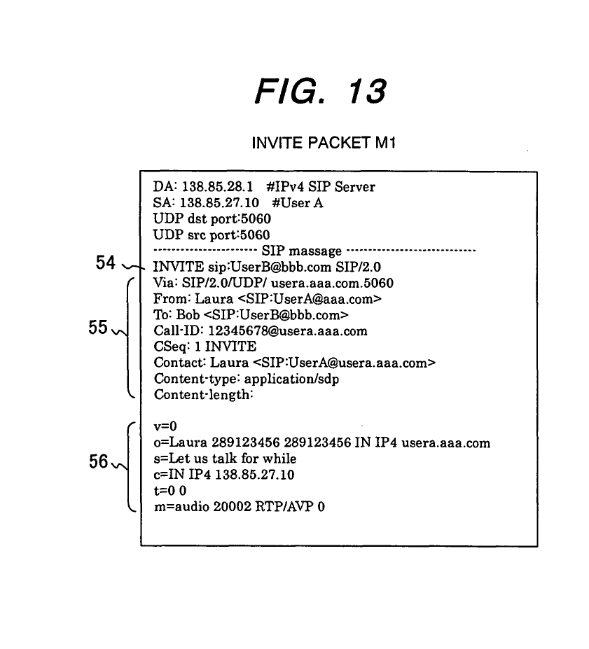

FIG. 13 is a diagram showing an example of an INVITE packet M1 in FIG. 8.

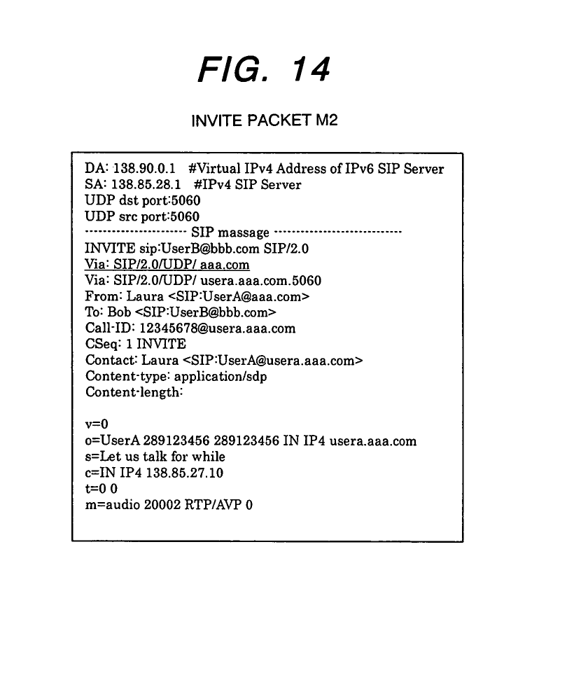

FIG. 14 is a diagram showing an example of an INVITE packet M2 in FIG. 8.

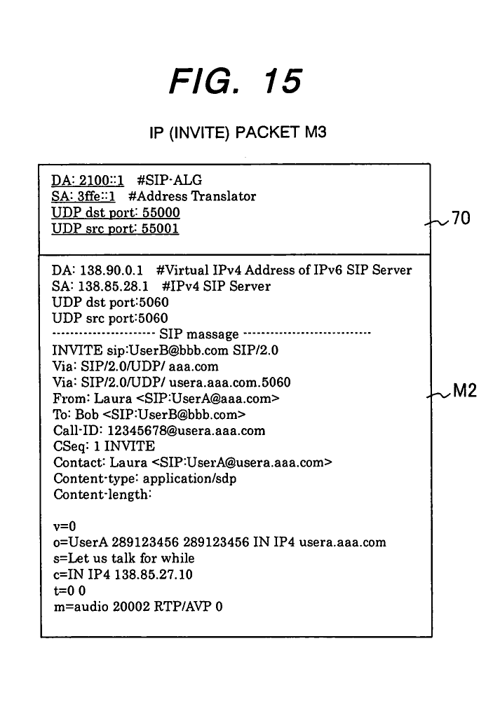

FIG. 15 is a diagram showing an example of an IP (INVITE) packet M3 in FIG. 8.

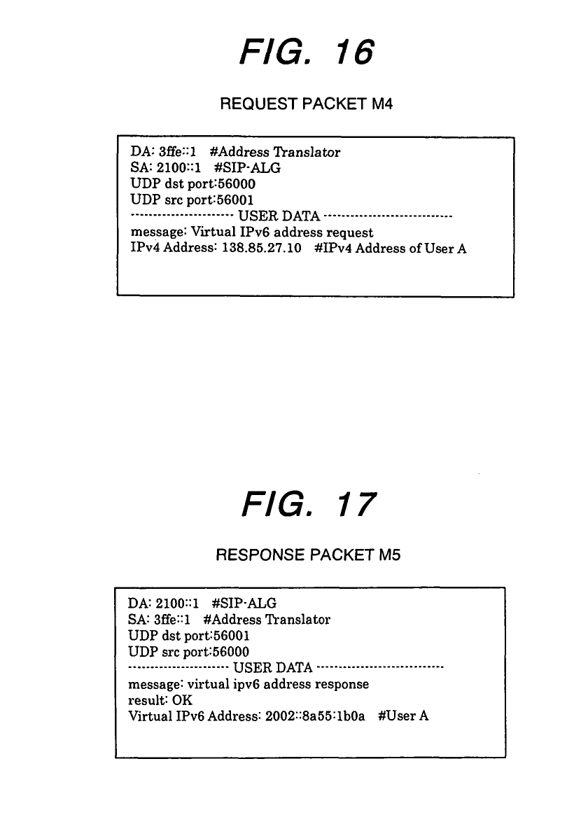

FIG. 16 is a diagram showing an example of a REQUEST packet M4 in FIG. 8.

FIG. 17 is a diagram showing an example of a RESPONSE packet M5 in FIG. 8.

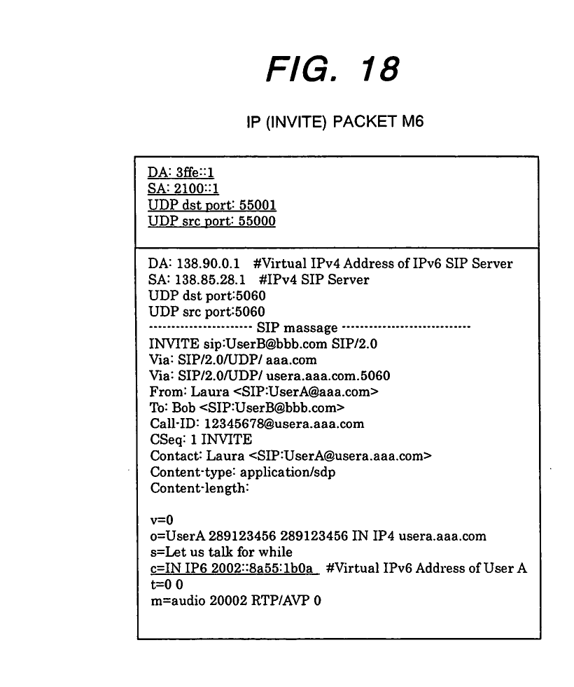

FIG. 18 is a diagram showing an example of an IP (INVITE) packet M6 in FIG. 8.

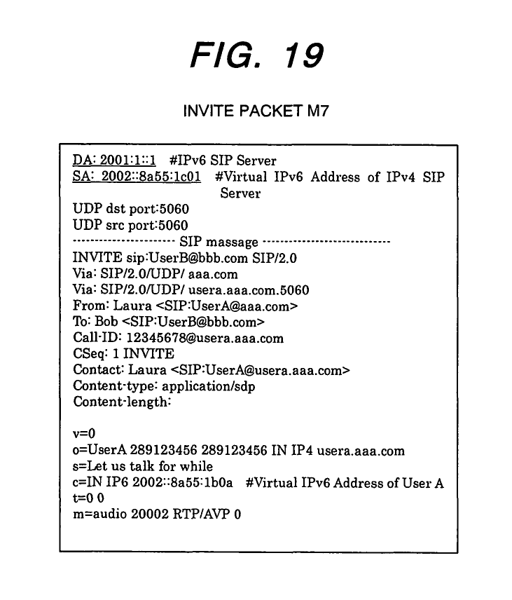

FIG. 19 is a diagram showing an example of an INVITE packet M7 in FIG. 8.

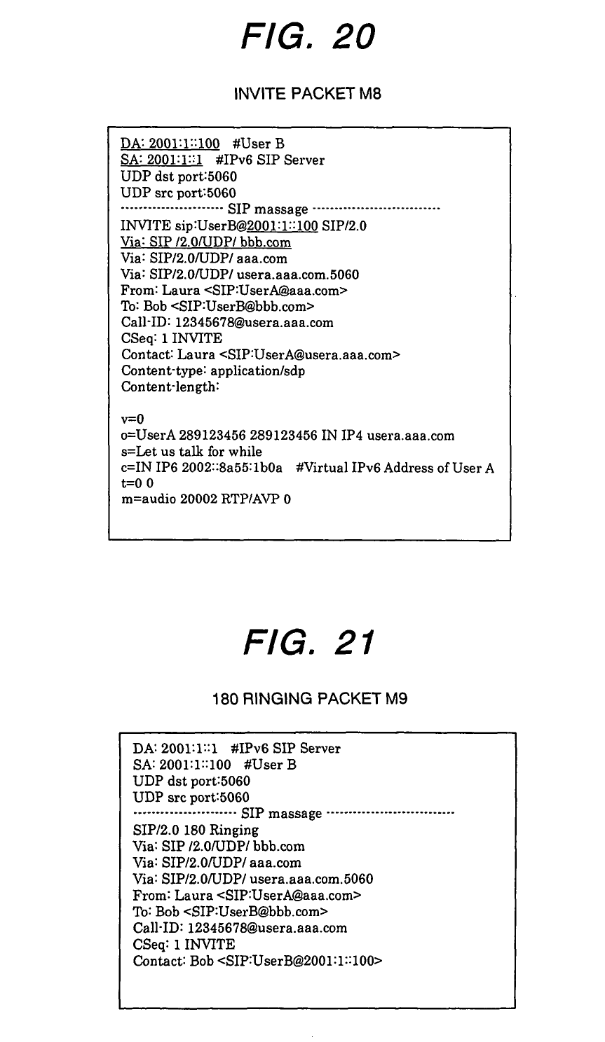

FIG. 20 is a diagram showing an example of an INVITE packet M8 in FIG. 8.

FIG. 21 is a diagram showing an example of a 180 RINGING packet M9 in FIG. 8.

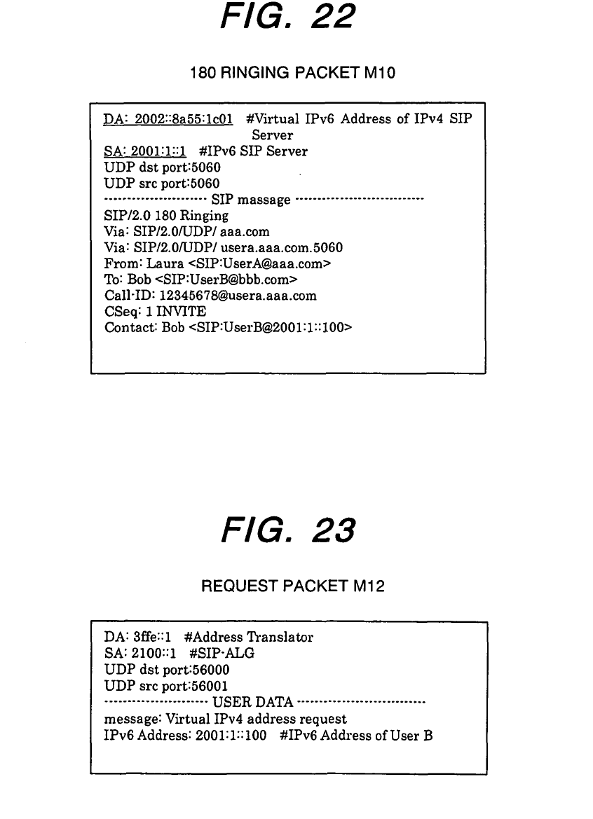

FIG. 22 is a diagram showing an example of a 180 RINGING packet M10 in FIG. 8.

FIG. 23 is a diagram showing an example of a REQUEST packet M12 in FIG. 8.

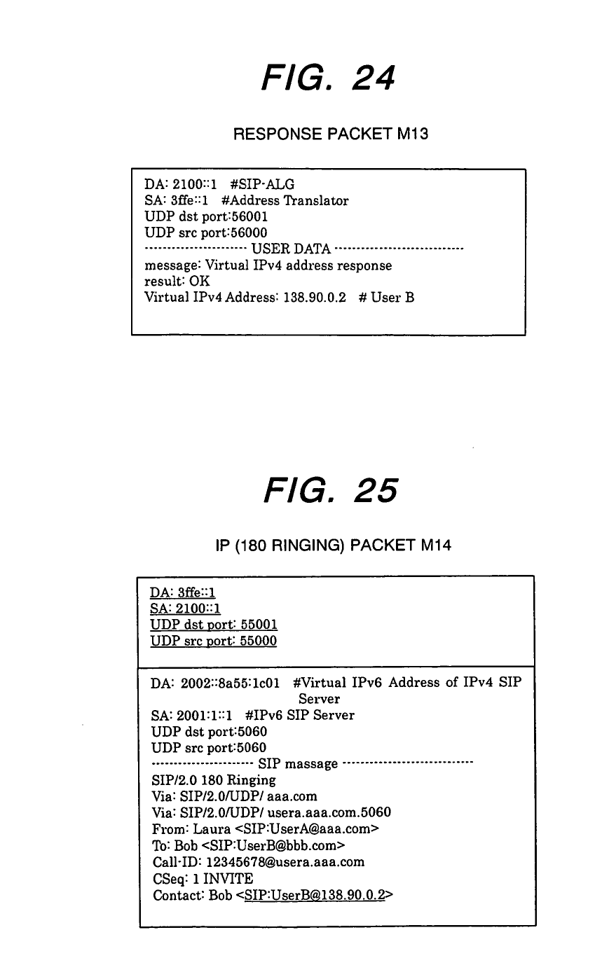

FIG. 24 is a diagram showing an example of a RESPONSE packet M13 in FIG. 8.

FIG. 25 is a diagram showing an example of an IP (180 RINGING) packet M14 in FIG. 8.

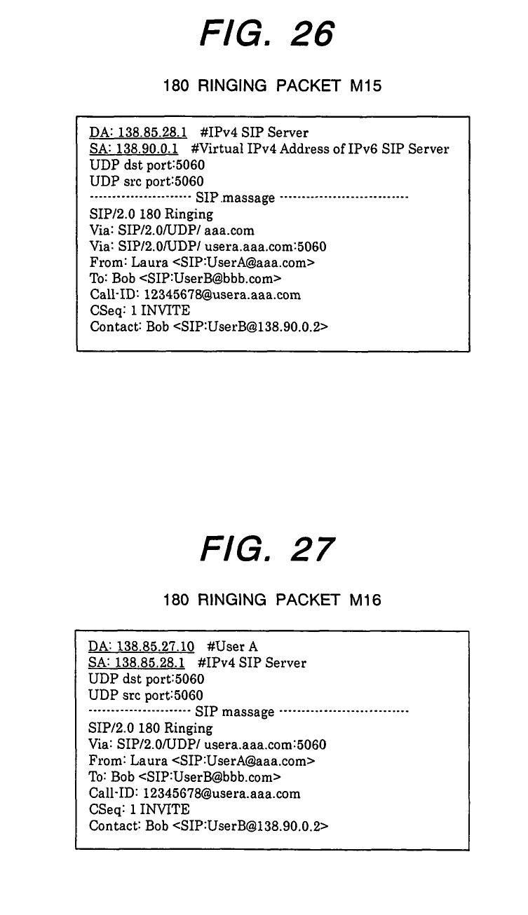

FIG. 26 is a diagram showing an example of a 180 RINGING packet M15 in FIG. 8.

FIG. 27 is a diagram showing an example of a 180 RINGING packet M16 in FIG. 8.

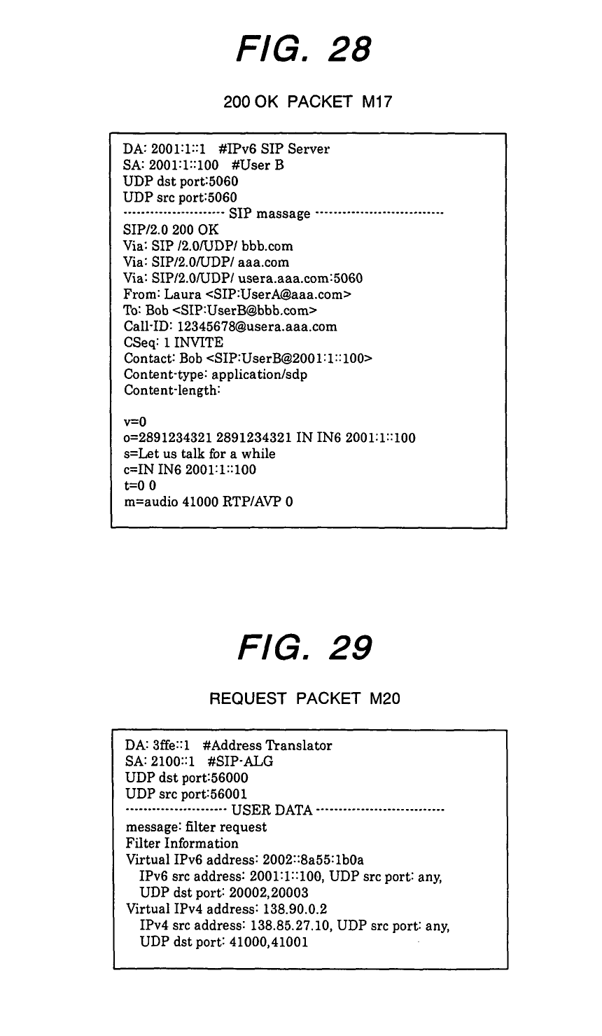

FIG. 28 is a diagram showing an example of a 200 OK packet M17 in FIG. 9.

FIG. 29 is a diagram showing an example of a REQUEST packet M20 in FIG. 9.

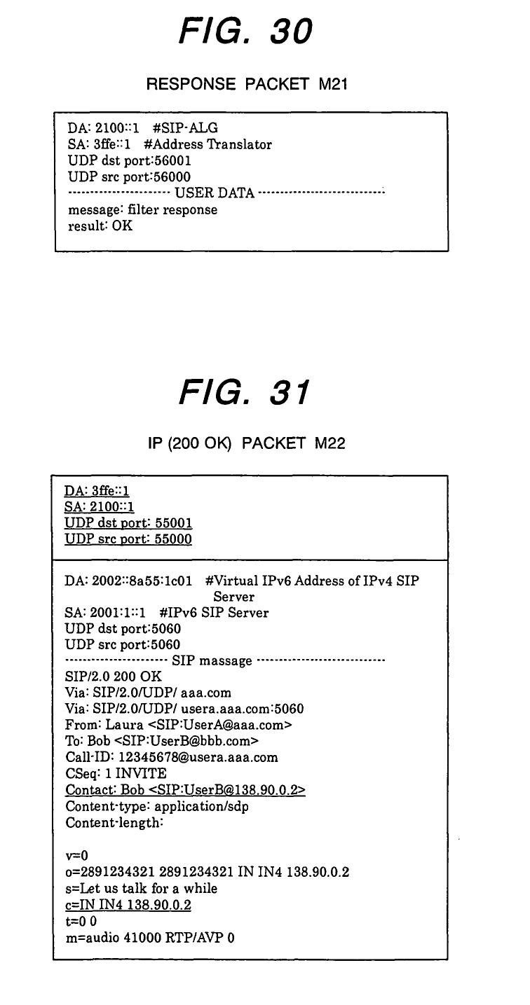

FIG. 30 is a diagram showing an example of a RESPONSE packet M21 in FIG. 9.

FIG. 31 is a diagram showing an example of an IP (200 OK) packet M22 in FIG. 9.

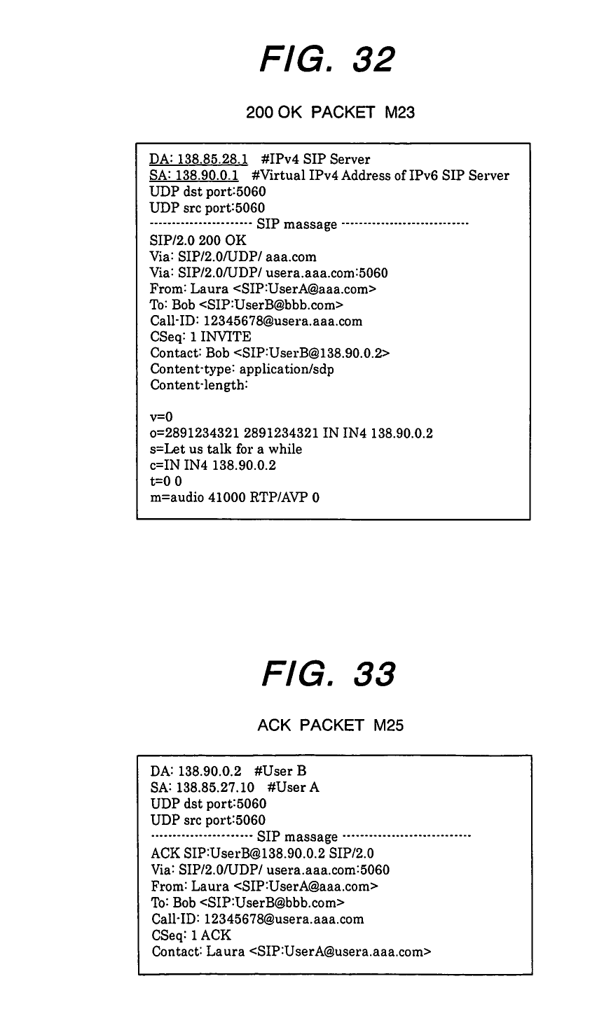

FIG. 32 is a diagram showing an example of a 200 OK packet M23 in FIG. 9.

FIG. 33 is a diagram showing an example of an ACK packet M25 in FIG. 9.

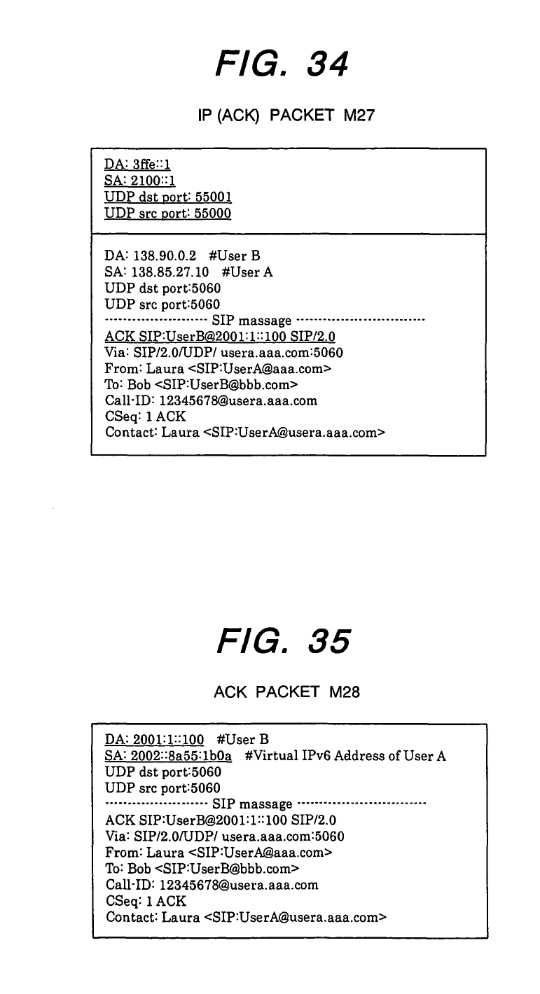

FIG. 34 is a diagram showing an example of an IP (ACK) packet M27 in FIG. 9.

FIG. 35 is a diagram showing an example of an ACK packet M28 in FIG. 9.

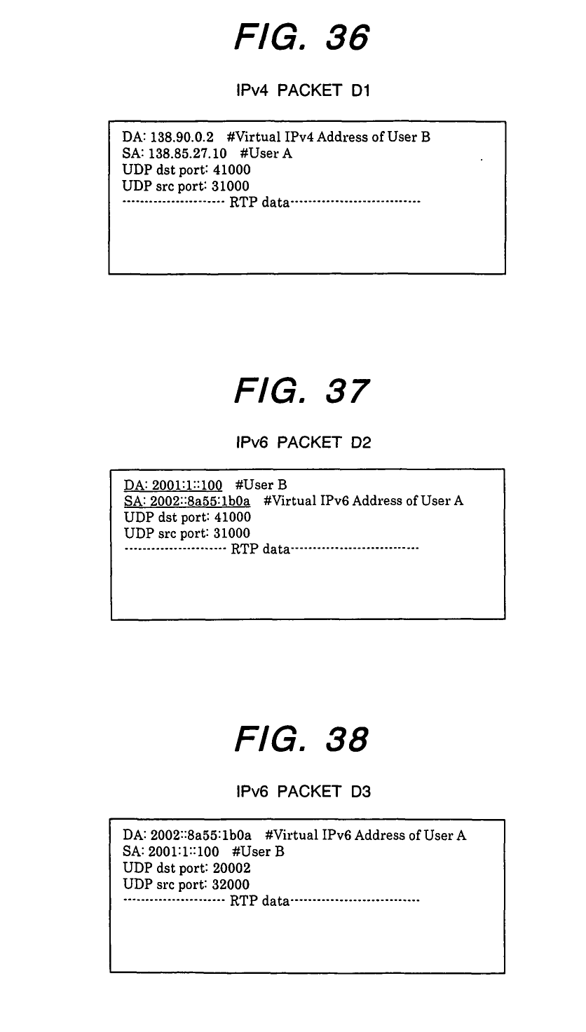

FIG. 36 is a diagram showing an example of an IPv4 packet D1 in FIG. 10.

FIG. 37 is a diagram showing an example of an IPv6 packet D2 in FIG. 10.

FIG. 38 is a diagram showing an example of an IPv6 packet D3 in FIG. 10.

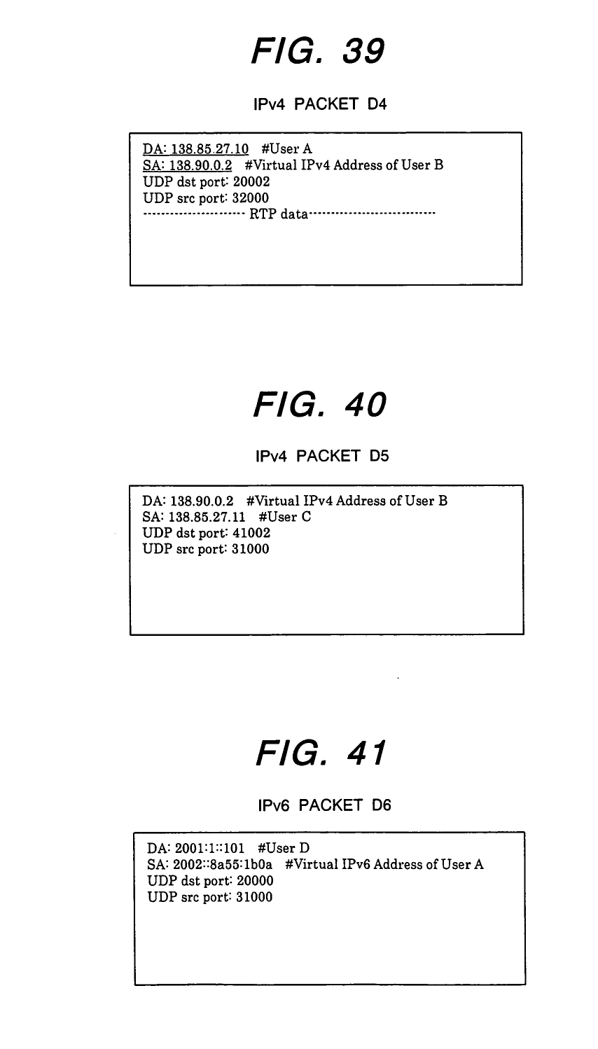

FIG. 39 is a diagram showing an example of an IPv4 packet D4 in FIG. 10.

FIG. 40 is a diagram showing an example of an IPv4 packet D5 in FIG. 10.

FIG. 41 is a diagram showing an example of an IPv6 packet D6 in FIG. 10.

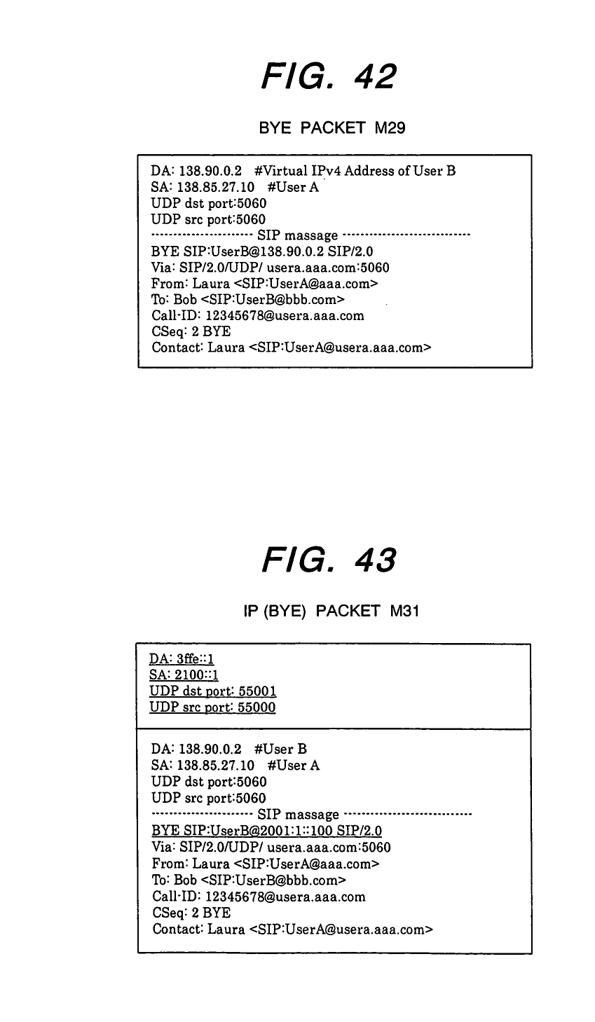

FIG. 42 is a diagram showing an example of a BYE packet M29 in FIG. 11.

FIG. 43 is a diagram showing an example of an IP (BYE) packet M31 in FIG. 11.

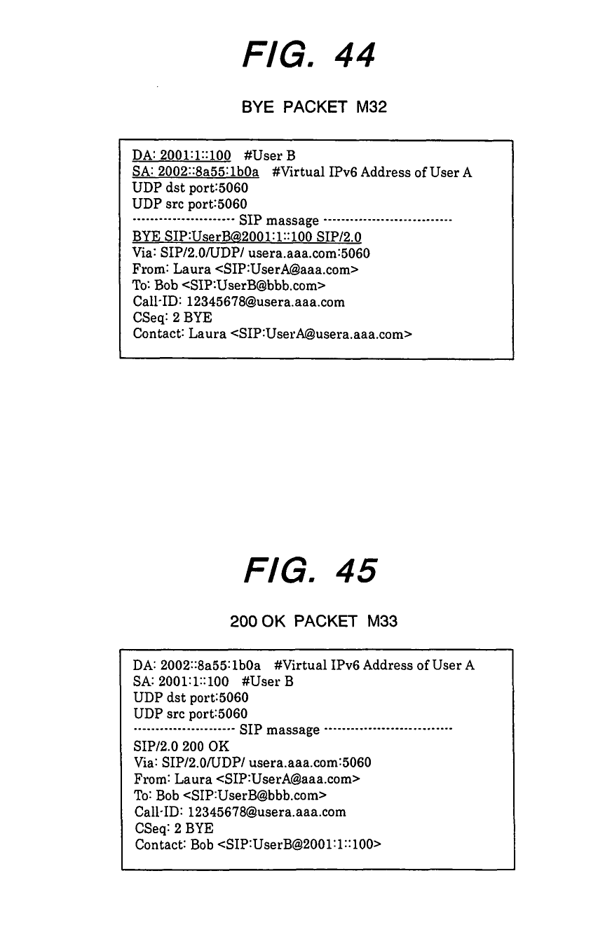

FIG. 44 is a diagram showing an example of a BYE packet M32 in FIG. 11.

FIG. 45 is a diagram showing an example of a 200 OK packet M33 in FIG. 11.

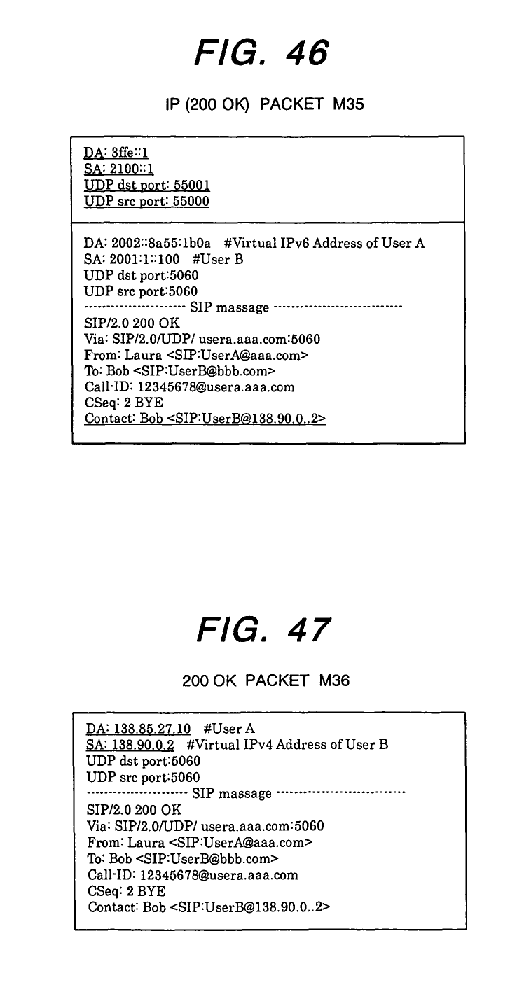

FIG. 46 is a diagram showing an example of an IP (200 OK) packet M35 in FIG. 11.

FIG. 47 is a diagram showing an example of an OK packet M36 in FIG. 11.

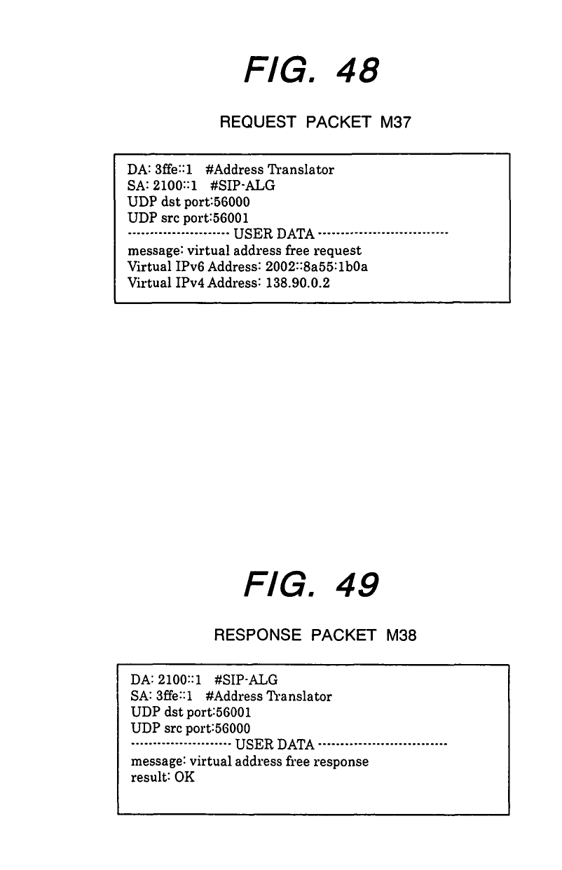

FIG. 48 is a diagram showing an example of a REQUEST packet M37 in FIG. 11.

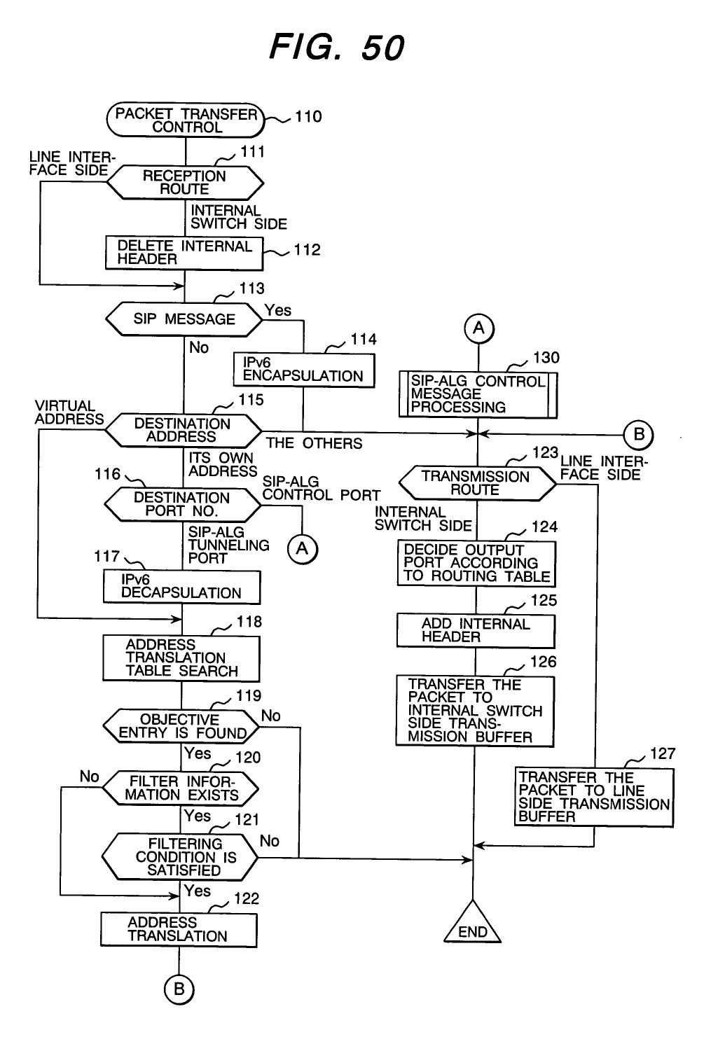

FIG. 49 is a diagram showing an example of a REPONSE packet M38 in FIG. 11.

FIG. 50 is a flowchart showing an example of a packet transfer control program 110.

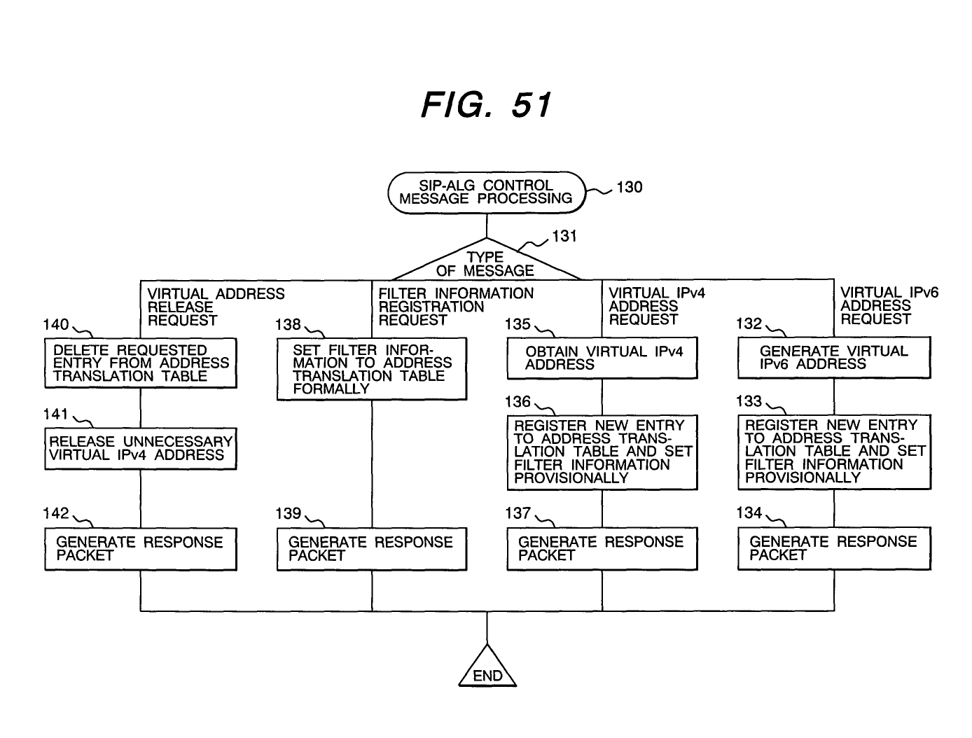

FIG. 51 is a flowchart showing an example of a SIP-ALG control message processing 130.

### DESCRIPTION OF THE PREFERRED EMBODIMENTS

Embodiments of the invention will be described hereinbelow with reference to the drawings.

FIG. 1 shows an example of a communication network to which an address translator of the invention is applied.

In FIG. 1, reference numeral 1 denotes a packet transfer apparatus having an address translating function between an IPv4 address and an IPv6 address which will be described later and is connected to a plurality of IP networks 2 (2-1 to 2-m) and a SIP-ALG (Application Level Gateway) 7 functioning as an apparatus for translating the payload of a SIP message. In the example shown in the diagram, IPv4 networks 2-1, 2-2, . . . having IPv4 SIP servers 3-1, 3-2, . . . and IPv6 networks 2-k, . . . , and 2-m having IPv6 SIP servers 3-k, . . . , and 3-m are connected to the packet transfer apparatus 1.

To the IPv4 networks 2-1, 2-2, . . . , IPv4 terminals 5 (5A, 5B, 5C, . . . ) and servers 8 (8A, 8C, . . . ) are connected. To the IPv6 networks 2-k, . . . , and 2-m, IPv6 terminals 6 (6A, 6B, . . . , and 6N) and servers 9 (9A, . . . , and 9N) are connected. Although not shown in the drawing for simplification, for example, a number of various servers such as a DNS (Domain Name System) server and communication nodes are connected to each of the IP networks 2.

In the embodiment, the operation of the packet transfer apparatus 1 of the invention will be described, as an example, by taking the case of establishing a session between the IPv4 terminal 5A having the ID “IPv4 User A” connected to the IPv4 network 2-1 and the IPv6 terminal 6B having the ID “IPv6 User B” connected to the IPv6 network 2-k, via the IPv4 SIP server 3-1, the packet transfer apparatus 1 and the IPv6 SIP server 3-k, and performing IP packet communication.

FIG. 2 is a block diagram showing an example of the configuration of the packet transfer apparatus 1.

The packet transfer apparatus 1 is comprised of line interfaces 11-1 to 11-m connected to the IP networks 2-1 to 2-m via input/output lines L1 to Lm, respectively, a line interface 11-n connected to the SIP-ALG 7 via an input/output line Ln; protocol processing units 12 (12-1 to 12-n) connected to the line interfaces, an internal switching unit 13 connected to the protocol processing units 12-1 to 12-n, and a control unit 14 connected to the protocol processing units 12-1 to 12-n and the internal switching unit 13 via a bus 15. To the control unit 14, a control terminal 90 is connected via a line 16.

Packets received from each of the IP networks 2 are transferred to the protocol processing unit 12 (12-1 to 12-m) via the line interface 11 (11-1 to 11-m). The protocol processing unit 12 (12-1 to 12-m) refers to a routing table in accordance with each destination IP address included in the IP header of the received packet, and outputs the received packet to an internal switch input/output port P (P1 to Pm) after adding internal routing information (internal header) designated in the routing table to each received packet.

In the embodiment described hereinafter, IP address translation is carried out by the protocol processing units each connected to the IPv4 network via the line interface. The protocol processing units each connected to the IPv6 network relays the received IPv6 packets to the internal switching unit without translating the address of the received IPv6 packets.

The protocol processing unit 12-i connected to the IPv4 network performs address translation in accordance with the address translation table if the destination of a data packet received from the line interface indicates a terminal (or server) connected to the IPv6 network, rewrites the IPv4 header of the received packet to an IPv6 header, adds an internal header to the rewritten packet, and supplies the resultant packet to the internal switching unit. In the case where the destination of a data packet received from the line interface indicates a terminal (or server) connected to the IPv4 network, the protocol processing unit 12-i adds an internal header to the received data packet without translating the address, and supplies the resultant data packet to the internal switching unit.

When a received packet from a line interface includes a SIP message for session control between terminals, the protocol processing unit 12-i encapsulates the received packet with an IP header having the address of the SIP-ALG 7 as a destination address, adds an internal header to the encapsulated packet, and outputs the resultant packet to the internal switching unit. When the encapsulated packet having been subjected to translation of the address in a SIP payload is received from the SIP-ALG 7 via the internal switching unit, the protocol processing unit 12-i deletes the encapsulation header, translates the address of an IP header as necessary, adds an internal header to the packet, and supplies the resultant packet to the internal switching unit.

The internal switching unit 13 routes the packets received from the ports P1 to Pn in accordance with the internal routing information and transfers each packet to one of the protocol processing units corresponding to the destination address.

Upon receiving the packet from the internal switching unit 13, each protocol processing unit deletes the internal header from the received packet. In the case where the received packet includes a SIP-ALG control message, the protocol processing unit 12-i executes operations of assigning a virtual IP address, updating an address translation table (registration of an entry, addition of filtering information, and deletion of an existing entry), returning a response packet to the SIP-ALG 7, and the like in accordance with a SIP-ALG control message processing program which will be described later.

One of the features of the invention resides in that, when a data packet is received from the line interface 11-i (or internal switch), the protocol processing unit 12-i determines whether the received packet is valid or not on the basis of the filtering information in the address translation table and discards an invalid packet which has not been subjected to a session establishing process.

FIG. 3 shows an example of the configuration of the control unit 14.

The control unit 14 is comprised of a processor 20, a program memory 21, a data memory 22, an inter-processor communication interface 23 connected to the bus 15, a terminal interface 24 connected to the line 16, and an internal bus 25 for mutually connecting those elements. In the memory 21, for example, a basic control program 210, an IPv4 routing operation program 211, and an IPv6 routing operation program 212 are stored. The processor 20 performs communication with the control terminal 90 in accordance with the basic control program 210, generates routing information in accordance with the IPv4 routing operation program 211 and IPv6 routing operation program 212, and updates a routing table of each of the protocol processing units 12.

FIG. 4 shows an example of the configuration of the protocol processing unit 12-1 connected to the IPv4 network and having an address translating function.

The protocol processing unit 12-1 is comprised of a line side receiving buffer 31 and a line side transmission buffer 32 connected to the line interface 11-1, an internal switch side transmission buffer 33 and an internal switch side receiving buffer 34 connected to the internal switch input/output port P1, a protocol processor 35 connected to the buffers, a program memory 36 and a data memory 37 connected to the protocol processor 35 via an internal bus 39, and an inter-processor communication interface 38 connected to the bus 15 of the packet transfer apparatus 1. The protocol processor 35 functions as an address translator.

In the data memory 37, tables prepared are an IPv4 routing table 310 for retrieving internal routing information on the basis of a destination IPv4 address attached to a received packet, an IPv6 routing table 320 for retrieving internal routing information on the basis of a destination IPv6 address attached to a received packet, an address translation table 330 for use in address translation between an IPv4 address and a virtual IPv6 address and between an IPv6 address and a virtual IPv4 address, and a virtual address pool 340.

A virtual IPv6 address to be used as a source address at the time of transferring an IPv4 packet to an IPv6 network can be automatically generated by combining a group of upper bits (prefix) in an IPv6 address assigned to the protocol processor (address translator) 35 and a source IPv4 address. Consequently, as the virtual address pool 340, it is sufficient to prepare only a virtual IPv4 address pool for storing virtual IPv4 addresses available to IPv6 terminals (or IPv6 address).

In the program memory 36, for example, a routing entry management program 100 for updating the routing table 310 (320), a packet transfer control program 110, a SIP-ALG control message processing program 130, and the other programs 150 are prepared. The protocol processor (address translator) 35 realizes the above-described address translation, addition and deletion of the internal header, and transfer of received packets by processing the packets stored in the receiving buffers 31 and 34 in accordance with the packet transfer control program 110. The SIP-ALG control message processing program 130 is activated by the packet transfer control program 110 when the received packet includes a SIP-ALG control message transmitted from the SIP-ALG 7.

FIG. 5 shows a packet format of a SIP message transmitted for establishing and disconnecting a session.

The SIP message is set in a payload 53 of an IP packet having an IP header 51 and a TCP/UDP header 52. The SIP message is constructed by a start-line 54 indicative of the type of the SIP message and the destination, a message-header 55 including SIP parameters, and a message-body 56 in which information of connection logically formed between terminals is described. Concrete contents of the SIP message will be described later with reference to FIGS. 13 to 35.

FIG. 6 shows the format of an IPv4 packet header, and FIG. 7 shows the format of an IPv6 packet header. An IPv4 packet header 60v4 includes a source address 61v4 and a destination address 62v4 each having a length of 32 bits. An IPv6 packet header 60v6 includes a source address 61v6 and a destination address 62v6 each having a length of 128 bits. The address translation in the invention denotes replacement of IP addresses and also translation of the header format.

An IPv4 address is expressed in a form in which the 32-bit address is divided into four blocks each consisting of 8 bits, the bit values of each block are expressed by numbers from 0 to 255, and bit values of the blocks are delimited by dot marks like “138.85.27.10”. On the other hand, an IPv6 address is expressed in a form in which the 128-bit address is divided into eight blocks each consisting of 16 bits, the bit values of each block is expressed by a four-digit octal value, and bit values of the blocks are delimited by colon marks like “2001:1::100”. Here, the continuous colon “::” denotes that blocks of zero bits are continued.

With reference to the sequence charts shown in FIGS. 8 to 11 and the address translation table 330 shown in FIG. 12, the operation of the address translator 35 of the case where the IPv4 terminal 5A performs communication with the IPv6 terminal 6B will be described hereinbelow.

It is assumed here that the IP address and URI (Uniform Resource Identifier) of the IPv4 terminal 5A as an originating side are “138.85.27.10” and “usera.aaa.com”, respectively. The IP address and URI of the IPv6 terminal 6B as a terminating side are “2001:1::100”and “userb.bbb.com”, respectively. The IP address and URI of the originating-side IPv4 SIP server 3-1 belonging to the IPv4 network 2-1 are “138.85.28.1” and “aaa.com”, respectively. The IP address and URI of the terminating-side IPv6 SIP server 3-k belonging to the IPv6 network 2-k are “2001:1::1” and “bbb.com”, respectively.

In the packet transfer apparatus 1, the processor 35 of the protocol processing unit 12-1 connected to the line interface 11-1 for the IPv4 network 2-1 will be called an address translator and its IPv6 address is assumed as “3ffe::1”. Further, it is assumed that the virtual IPv6 address assigned by the address translator 35 to the iPv4 address of the originating-side IPv4 terminal at the time of establishment of a session comprises the upper 96 bits having a prefixed value “2002::” and the lower 32 bits having the value of the originating-side IPv4 address. It is assumed that the upper 24 bits of the virtual IPv4 address assigned as the IPv6 address of the terminating-side IPv6 terminal have a prefixed value “138.90.0.0”.

First, with reference to FIG. 8, the session establishing sequence will be described.

Prior to data packet communication with the IPv6 terminal, the originating-side IPv4 terminal 5A sends an INVITE packet M1 including a SIP message for requesting session establishment to the IPv4 SIP server 3-1 (401). As shown in FIG. 13, the INVITE packet M1 includes the IP address of the IPv4 SIP server 3-1 as a destination address DA of the IP header, the IP address of the IPv4 terminal (User A) 5A as a source address SA, and the port number “5060” for SIP as the UDP header. In the diagram, a character train following the symbol # is added for notes and is not packet information.

The SIP message includes, in the start line 54, the message kind “INVITE” and the URI of the terminating-side IPv6 terminal (User B). In the message header 55, the URI and the port number of the originating-side terminal 5A are designated by the “Via” header indicative of a message path, the destination ID of the request is designated in the “To” header, the source ID of the request is designated in the “From” header, and the session (call) ID is designated by Call-ID. In the message body 56, the IP address of the originating-side terminal is designated by “c” parameter, and the port number “20002” for data reception at the originating-side terminal is designated by “m” parameter.

The INVITE packet M1 is received by the IPv4 SIP server 3-1 in the IPv4 network 2-1. Upon receiving the INVITE packet M1, the IPv4 SIP server 3-1 adds a new Via header to the message header of the SIP message in order to add the server itself into the message path as shown by an underline in FIG. 14, rewrites the destination IP address DA and the source IP address SA of the IP header to the virtual IPv4 address of the IPv6 SIP server 3-k and the IPv4 address of the server itself, respectively, and transmits the resultant packet as an INVITE packet M2 to the IPv4 network 2-1 (402).

The virtual IPv4 address of the IPv6 SIP server 3-k is retrieved on the basis of the domain name “bbb.com” of the destination identifier indicated by the To header of the SIP message. For simplicity of description, it is assumed that the IPv4 SIP server 3-1 has a table indicative of the corresponding relation between the destination domain name “bbb.com” and the virtual IPv4 address “138.90.0.1”, and the virtual IPv4 address is retrieved from the table. In actual application, it is possible to inquire a DNS server connected to the IPv4 network 2-1 of an IP address and obtain the virtual IPv4 address “138.90.0.1” as a response from the DNS server.

The INVITE packet M2 is received by the packet transfer apparatus 1 (address translator 35). Upon receiving the INVITE packet M2, the address translator 35 judges, from the value (“5060”) of the UDP port, that the received is a packet for SIP message (403). In this case, as shown in FIG. 15, the address translator 35 adds a new header 70 to the received packet M2 and transfers the resultant packet as an encapsulated IP (INVITE) packet M3 to the SIP-ALG 7 (404). The header 70 includes the IPv6 address “2100::1” of the SIP-ALG 7 as the destination IP address DA, the IPv6 address “3ffe::1” of the address translator as the source address SA, “55000” as a UDP destination port number, and “55001” as a UDP source port number.

Upon receiving the IP (INVITE) packet M3, the SIP-ALG 7 transmits a REQUEST packet M4 to the address translator 35 while holding the received packet M3 in a memory (405). The REQUEST packet M4 includes, as shown in FIG. 16, the IPv6 address “3ffe::1” of the address translator as the destination IP address DA, the IPv6 address “2100::1” of the SIP-ALG 7 as the source address SA, “56000” as the UDP destination port number, and “56001” as the UDP source port number. The payload (USER DATA) of the packet M4 includes a message name indicating that the packet is for virtual IPv6 address assignment request and an IPv4 address to which the virtual IPv6 address will be assigned. In this case, as the IPv4 address, the IP address “135.85.27.10” of the IPv4 terminal 5A indicated by the c parameter in the IP (INVITE) packet M3 is set.

Upon receiving the REQUEST packet M4, the address translator 35 generates a virtual IPv6 address “2002::8a55:1b0a” to be assigned to the originating-side IPv4 terminal 5A from the designated IPv4 address “135.85.27.10” (=“8a55:1b0a”) and the above-described prefixed value “2002::” for the virtual IPv6 address, registers a translation information entry indicative of the relation between the IPv4 address and the virtual IPv6 address into the address translation table 330 (406) and transmits a RESPONSE packet M5 to the SIP-ALG 7 (407).

The RESPONSE packet M5 includes, as shown in FIG. 17, the port numbers “56001” and “56000” designated by the REQUEST packet M4 as the UDP destination port number and the UDP source port number and includes, in the payload (USER DATA), the message name indicating that the packet is a response to the virtual IPv6 address assignment request, the result (“OK”) to the request, and the value “2002::8a55:1b0a” of the assigned virtual IPv6 address.

As shown in FIGS. 12A to 12C, the address translation table 330 is comprised of a plurality of entries each indicating the relation of an IPv4 address 331, an IPv6 address 332, and filter information 333. As shown in FIG. 12A, the address translation table 330 includes, as fixed entries, an entry EN1 indicative of the relation between the virtual IPv4 address and the IPv6 address of the IPv6 SIP server 3-k, and an entry EN2 indicative of the relation between the IPv4 address and the virtual IPv6 address of the iPv4 SIP server 3-1. To discriminate from the real IP address, the virtual IP address is underlined here. In practice, for example, as an entry for the SIP server 3-m of the IPv6 network 2-m shown in FIG. 1, other fixed entries are also registered. However, these entries are not shown here because they have no relation to the description of the operation of the embodiment.

The filter information 333 indicates a condition of determining validity of a received packet (filter condition) to be referred to in advance of the address translating process. The filter information 333 includes a validity indication bit 333A, source address 333B, type of the port 333C, a source port number 333D, and a destination port number 333E. The address of a received packet corresponding to an entry whose validity indication bit 333A is “0” is translated irrespective of the filter conditions. The address of a received packet corresponding to an entry of whose validity indication bit 333A is “1” is translated if the filter condition is satisfied. A received packet which does not satisfy the filter condition and a received packet having no corresponding entry in the translation table are judged as wrong packets which are beside the address translation and treated as packets for discard.

In response to reception of the REQUEST packet M4, the address translator 35 adds an entry EN3 to the address translation table 330 as shown in FIG. 12B in step 406. At this time, since the session is in process of establishment and filter information is incomplete, the value “::0” is set to the source address 333B as provisional filter information. The entry EN3 is referred to when a data packet designating the IPv4 terminal 5A with the virtual IPv6 address is received in order to translate the destination address from the virtual IPv6 address to the IPv4 address. A source terminal of a packet requiring the entry EN3 is the session terminating side IPv6 terminal 6B.

If the IPv6 address “::0” is set to the source address 333B as provisional filter information in the entry EN3, since no terminal having the IPv6 address “::0” exists in the IPv6 networks, any terminal can't satisfy the filter conditions. Therefore, until the session has been established, the address translator 35 can judge all of data packets using the virtual IPv6 address “2002::8a55:1b0a” for a destination address as invalid packets, and discard them without performing address translation.

Upon receiving the RESPONSE packet M5, the SIP-ALG 7 translates the value of the c parameter in the IP (INVITE) packet M3 held theretofore from the IPv4 address to the virtual IPv6 address “2002::8a55:1b0a” (SIP payload translation: 408), and transmits an encapsulated IP (INVITE) packet M6 shown in FIG. 18 to the address translator 35 (409). The encapsulation header of the packet M6 is generated based on the encapsulation header of the IP (INVITE) packet M3. The contents of the IP (INVITE) packet M6 is stored in the SIP-ALG 7 in order to generate a filter request packet M20 as will be described later.

When the IP (INVITE) packet M6 is received, the address translator 35 deletes the encapsulation header from the received packet, extracts the IP packet M3 subjected to the SIP payload translation, and translates the destination address DA and the source address SA of the IP header from the IPv4 to IPv6 (410). The address translation of the destination address DA and the source address SA are carried out according to the entry EN1 and entry EN2 in the address translation table 330, respectively. The address-translated IP packet is transmitted as an INVITE packet M7 shown in FIG. 19 to the IPv6network 2-k (411) and is received by the IPv6 SIP server 3-k.

When the INVITE packet M7 is received, the IPv6 SIP server 3-k specifies the IPv6 address “2001:1::100” of the terminating-side IPv6 terminal 6B on the basis of the destination ID “Userb@bbb.com” indicated in the start line of the SIP message, rewrites a part of the destination ID with the IPv6 address as shown in FIG. 20, adds a new Via header to the message header in order to add the server itself to the message path, rewrites the destination address DA and the source address SA of the packet M7, and transfers the resultant packet as an INVITE packet M8 to the terminating-side iPv6 terminal 6B (412). The IPv6 address “2001:1::100” may be specified by inquiring a DNS server connected to the IPv6 network 2-k like the IPv4 SIP server 3-1 does.

In response to the INVITE packet M8, the terminating-side IPv6 terminal 6B transmits a 180 RINGING packet M9 including the SIP message for ringing (413). As shown in FIG. 21, the 180 RINGING packet M9 designates the type of message of “180 Ringing” in the start line of the SIP message, and includes Via header, From header, To header and Call-ID in the message header similar to those in the INVITE packet M8. The IPv6 address “2001:1::100” of the terminating-side IPv6 terminal 6B is designated in the Contact header. The destination IP address DA of the IP header and the destination and source port numbers of the UDP are specified from the IP header of the INVITE packet M8.

The 180 RINGING packet M9 is received by the IPv6 SIP server 3-k and transferred to the IPv6 network as a header-translated 180 RINGING packet M10 shown in FIG. 22 (414). At this time, the Via header corresponding to the IPv6 SIP server 3-k is deleted from the message header of the SIP message, and the virtual IPv6 address of the IPv4 SIP server 3-1 as the destination IP address is specified on the basis of the URI “aaa.com” indicated by the next Via header.

The 180 RINGING packet M10 is received by the packet transfer apparatus 1 and transferred to the address translator 35 via the internal switching unit 13. When the 180 RINGING packet M10 is received, the address translator 35 judges from the value of the UDP port number that the received packet includes a SIP message (415), encapsulates the received packet with a header similar to that of the IP (INVITE) packet M3, and transfers the encapsulated packet as an IP (RINGING) packet M11 to the SIP-ALG 7 (416).

Upon receiving the IP (RINGING) packet M11, the SIP-ALG 7 transmits a REQUEST packet M12 to the address translator 35 while holding the received packet (417). As shown in FIG. 23, the REQUEST packet M12 has a header similar to that of the REQUEST packet M4 and includes in the payload (USER DATA), message name indicating that the packet is one for virtual IPv4 address assignment request and the IPv6 address of the terminating-side. IPv6 terminal 6B to which a virtual IPv4 address is required. In this case, as the IPv6 address, the IP address “2001:1::100” of the IPv6 terminal 6B indicated in the Contact header of the IP (RINGING) packet M11 is set.

When the REQUEST packet M12 is received, the address translator 35 obtains a virtual IPv4 address to be assigned to the IPv6 terminal 6B from the virtual address pool 340, registers a new entry indicative of the relation between the virtual IPv4 address and the IPv6 address “2001:1::100” (418), and transmits a RESPONSE packet M13 to the SIP-ALG 7 (419).

In an entry registered in the address translation table 330 at this time, as shown by an entry EN4 in FIG. 12B, “0.0.0.0” is set to the source address 333B as temporary filter information. The RESPONSE packet M13 has, as shown in FIG. 24, a header similar to that of the RESPONSE packet M5 and includes message name indicating that the packet is one for response to the virtual IPv4 address assignment request, result (OK) to the request, and the value of the assigned virtual IPv4 address “138.90.0.2” in the payload.

When the RESPONSE packet M13 is received, the SIP-ALG 7 translates the IP address “2001:1::100” of the IPv6 terminal 6B indicated in the contact header of the IP (180 RINGING) packet M11 held theretofore into the virtual IPv4 address “138.90.0.2” indicated in the RESPONSE packet M13 (SIP payload translation: 420), and transmits the resultant packet as an IP (180 RINGING) packet M14 shown in FIG. 25 to the address translator 35 (421).

Upon receiving the IP (180 RINGING) packet M14, the address translator 35 deletes the encapsulation header from the received packet, extracts the 180 RINGING packet having a translated SIP payload, and translates the destination IP address and the source IP address from IPv6 to IPv4 in accordance with the entries EN1 and EN2 in the address translation table 330 (422). The address-translated packet is transmitted as a 180 RINGING packet M15 shown in FIG. 26 to the IPv4 network 2-1 (423), and transferred to the IPv4 SIP server 3-1.

When the 180 RINGING packet M15 is received, the IPv4 SIP server 3-1 deletes the Via header indicative of the URI of itself from the SIP message and rewrites, as shown in FIG. 27, the destination address to the IP address of the IPv4 terminal 5A corresponding to the URI indicated in the Via header of the SIP message and the source IP address to the IPv4 address of the IPv4 SIP server 3-1. The resultant packet is transferred as a 180 RINGING packet M16 to the IPv4 terminal 5A (424).

A communication sequence of the case where the IPv6 terminal 6B on the terminating side responds to the call will now be described with reference to FIG. 9.

When the terminating-side user responds to the call, a 200 OK packet M17 including a SIP response message is transmitted from the IPv6 terminal 6B to the IPv6 SIP server 3-k (430). As shown in FIG. 28, the 200 OK packet M17 indicates the type of the message “200 OK” in the start line of the SIP message and includes information similar to that of the INVITE packet M8 in the message header portion. In the message body, the IPv6 address of the terminating-side terminal (IPv6 terminal 6B) is designated by the c parameter, and the port number “41000” for data reception in the terminating-side terminal is designated by the m parameter.

When the 200 OK packet M17 is received, the IPv6 server 3-k deletes the Via header corresponding to the IPv6 SIP server 3-k from the message header of the SIP message, rewrites the destination address and the source address of the IP header like the case of the 180 RINGING packet M10, and transfers the resultant packet as a 200 OK packet M18 (431).

The 200 OK packet M18 is received by the packet transfer apparatus 1 and transferred to the address translator 35. The address translator 35 judges from the UDP port number in the 200 OK packet M18 that the received packet includes a SIP message (432) encapsulates the received packet with a header for the SIP-ALG 7 in a manner similar to the IP (INVITE) packet M3, and transfers the encapsulated packet as an IP (200 OK) packet M19 to the SIP-ALG 7 (433).

Upon receiving the IP (200 OK) packet M19, the SIP-ALG 7 transmits a REQUEST packet M20 shown in FIG. 29 to the address translator 35 while holding the received packet M19 (434). The REQUEST packet M20 is issued to request registration of filter information into the address translation table and includes in its payload (USER DATA), message name indicative of the filter information registration request, virtual IPv6 address, filter information in association with the virtual IPv6 address, virtual IPv4 address, and filter information in association with the virtual IPv4 address. The filter information is generated based on the contents of the IP (INVITE) packet M3 held in the SIP-ALG 7 and the IP (200 OK) packet M19.

The REQUEST packet M20 shown here desigantes, as filter information in association with the virtual IPv6 address “200::8a55:1b0a” for the originating-side IPv4 terminal, the IPv6 source address=“2001:1::100”, type of port=“UDP”, source port=“any”, and destination ports=“20002 and 20003”. As filter information in association with the virtual IPv4 address “138.90.0.2” for the terminating-side IPv6 terminal, IP source address=“138.85.27.10”, type of port=“UDP”, source port=“any”, and destination ports=“41000 and 41001”are designated. Although the m parameter of the IP (INVITE) packet M3 designates the port number=“20002” and the m parameter of the IP (200 OK) packet M13 designates the port number=“41000”, since the next number (odd-numbered) port is also used implicitly in RTP, two port numbers are designated in the destination port as the filter conditions.

Upon receiving the REQUEST packet M20, the address translator 35 refers to the address translation table 330, and sets the filter information designated by the received packet M20 to the entries EN3 and EN4 corresponding to the virtual IPv6 address “2002::8a55:1b0a” and the virtual IPv4 address “138.90.0.2” designated by the received packet M20, respectively (435). As a result, the address translation table is changed as shown in FIG. 12C. After completion of the setting of the filter information to the address translation table, the address translator 35 generates a RESPONSE packet M21 shown in FIG. 30 and transmits the packet M21 to the SIP-ALG 7 (436).

When the RESPONSE packet M21 is received, the SIP-ALG 7 translates the IPv6 addresses of the terminating-side terminal 6B indicated in the Contact header and the c parameter of the SIP message (refer to the 200 OK packet M17 in FIG. 28) in the IP (200 OK) packet M19 to the virtual IPv4 address “138.90.0.2” already received (SIP payload translation: 437), rewrites the address of the IP header, and transmits the resultant packet as an encapsulated IP (200 OK) packet M22 shown in FIG. 31 to the address translator 35 (438).

Upon receiving the IP (200 OK) packet M22, in a manner similar to the time of reception of the IP (RINGING) packet M11, the address translator 35 deletes the encapsulation header, translates the IP addresses of the 200 OK packet from the IPv6 address to the IPv4 address (439), and transfers the resultant packet as a 200 OK packet M23 shown in FIG. 32 to the IPv4 SIP server 3-1 (440).

The 200 OK packet is processed by the IPv4 SIP server 3-1 in a manner similar to the 180 RINGING packet M15. That is, the Via header for the IPv4 SIP server 3-1 is deleted from the message header, the destination IP address and the source IP address of the IP header are rewritten, and the resultant packet is transferred as a 200 OK packet M24 addressed to the originating-side IPv4 terminal 5A (441).

When the 200 OK packet M24 is received, the originating-side IPv4 terminal 5A transmits an ACK packet M25 shown in FIG. 33 (450). Since the ACK packet M25 includes the virtual IPv4 address “138.90.0.2” of the terminating-side terminal 6B as the destination IP address, this packet reaches the address translator 35 without passing through the IPv4 SIP server 3-1.

The address translator 35 judges from the UDP port number of the ACK packet M25 that the received packet includes a SIP message (451), and transfers the resultant packet as an IP (ACK) packet M26 to the SIP-ALG 7 after encapsulating the received packet with the IP header for the SIP-ALG 7 in a manner similar to the time of reception of the INVITE packet M2 (452).

Upon receiving the IP (ACK) packet M26, the SIP-ALG 7 translates the virtual IPv4 address “138.90.0.2” of the terminating-side IPv6 terminal indicated in the start header of the SIP message of the received packet into the IPv6 address “2001:1::100” (SIP payload translation: 453), rewrites the encapsulation header, and sends the resultant packet as an IP (ACK) packet M27 shown in FIG. 34 to the address translator 35.

When the IP (ACK) packet M27 is received, the address translator 35 deletes the encapsulation header, translates the destination IP address and the source IP address of the IP header from the IPv4 address to the IPv6 address (455), and transfers the resultant packet as an ACK packet M28 shown in FIG. 35 to the IPv6 network 2-k (456). When the ACK packet M28 is received by the terminating-side IPv6 terminal 6B, the session establishing sequence is completed.

A sequence of transferring data packets between the IPv4 terminal 5A and the IPv6 terminal 6B will be described by referring to FIG. 10.

As shown in FIG. 36, the IPv4 terminal 5A transmits user data by an IPv4 packet D1 having the virtual IPv4 address “138.90.0.2” of the IPv6 terminal 6B as the destination IP address and the port number “41000” designated by the IPv6 terminal 6B as the UDP destination port number (460). In FIG. 36, for simplicity, the data included in the data field of the IPv4 packet D1 is not shown but only the contents of the header is shown (also in FIGS. 37 to 41).

When the IPv4 packet D1 is received, the address translator 35 retrieves the entry EN4 corresponding to the destination IP address “138.90.0.2” from the address translation table 330 and checks the received packet in accordance with the filter information. In this case, the source IP address “138.85.27.10”, the type of port “UDP”, and destination port number “41000” of the IPv4 packet D1 satisfy the filter condition of the entry EN4. Consequently, the address translator 35 judges that the source of the IPv4 packet D1 is a valid terminal, and translates the destination IP address and the source IP address of the received packet from the IPv4 address to the IPv6 address in accordance with the address translation table 330 (461). By the above address translation, the IPv4 packet D1 is transferred as an IPv6 packet D2 shown in FIG. 37 to the IPv6 network 2-k (462) and received by the destination IPv6 terminal 6B.

On the other hand, the IPv6 terminal 6 transmits user data by an IPv6 packet D3 having, as shown in FIG. 38, the virtual IPv6 address “2002::8a55:1b0a” of the IPv4 terminal 5A as the destination IP address and the port number “20002” designated by the IPv4 terminal 5A as the UDP destination port number (463).

When the IPv6 packet D3 is received, the address translator 35 retrieves the entry EN3 corresponding to the destination IP address “2002::8a55:1b0a” from the address translation table 330 and checks the received packet in accordance with the filter information. In this case, the source IP address “2001:1::100” of the IPv6 packet D3, the port type “UDP”, and the destination port number “20002” satisfy the filter condition indicated in the entry EN3. Consequently, the address translator 35 judges that the source of the IPv6 packet D3 is a valid terminal, and translates the destination IP address and the source IP address of the received packet from the IPv6 address to the IPv4 address in accordance with the address translation table 330 (464). By the above address translation, the IPv6 packet D3 is transferred as an IPv4 packet D4 shown in FIG. 39 to the iPv4 network 2-1 (465) and received by the destination IPv4 terminal 5A.

Next, a case is assumed where another terminal, which has not participated in the establishment of the above-described session, transmits a data packet by applying the virtual IP address “138.90.0.2” or “2002::8a55:1b0a” as the destination IP address.

For example, when an IPv4 terminal 5B having an IP address “138.85.27.11” connected to the IPv4 network 2-1 transmits a data packet D5 using the virtual IPv4 address “138.90.0.2” as the destination IP address as shown in FIG. 40 (466), the address translator 35 retrieves the entry EN4 corresponding to the destination IP address “138.90.0.2” from the address translation table 330, and checks the received packet in accordance with the filter information. In this case, the source IP address “138.85.27.11” of the IPv4 packet D5 does not coincide with the source IP address “138.85.27.10” registered as the filter condition. The destination port number “41002” also does not coincide with the destination port number “41000” of the filter condition. Therefore, the address translator 35 judges that the source of the IPv4 packet D5 is invalid and discard the received packet (467).

Also in the case where the IPv6 terminal 6A having the IP address “2001:1:1::101” connected to the IPv6 network 2-k transmits a data packet D6 having, as shown in FIG. 41, the virtual IPv6 address “2002::8a55:1b0a” as a destination IP address (468), the address translator 35 can judge that the source of the received packet D6 is invalid for a reason similar to the above and discard the received packet (469).

A session disconnecting sequence will now be described with reference to FIG. 11.

For example, in the case where the user of the IPv4 terminal 5A performs an operation of a call disconnection, a BYE packet M29 including a SIP message for disconnecting the session is transmitted from the IPv4 terminal 5A (470). The BYE packet M29 in this case has, as shown in FIG. 42, an IP header and a UDP header similar to those of the ACK packet M25 and includes a message type of “BYE” and the virtual IPv4 address “138.90.0.2” of the terminating-side IPv6 terminal 6B in the start line of the SIP message.

When the BYE packet M29 is received, the address translator 35 determines from the UDP port number that the received packet includes a SIP message (471) and transfers the packet as an IP (BYE) packet M30 to the SIP-ALG 7 by encapsulating the received packet in a manner similar to the reception of the INVITE packet M2 (472).

When the IP (BYE) packet M30 is received, the SIP-ALG 7 translates the IPv4 address included in the SIP message. In this example, the virtual IPv4 address “138.90.0.2” in the start line is translated into an IPv6 address “2001:1::100” (SIP payload translation: 473) and the resultant packet is sent as an IP (BYE) packet M31 shown in FIG. 43 back to the address translator 35 (474).

Upon receiving the IP (BYE) packet M31, the address translator 35 deletes the encapsulation header, translates the destination IP address and the source IP address of the IP header from the IPv4 address to the IPv6 address (475), and transfers the resultant packet as a BYE packet M32 shown in FIG. 44 to the IPv6 network 2-k (476). The BYE packet M32 is transferred in accordance with the destination IPv6 address over the IPv6 network 2-k, and received by the IPv6 terminal 6B.

In response to the reception of the BYE packet M32, the IPv6 terminal 6B transmits a 200 OK packet M33 (480). The 200 OK packet M33 includes, as shown in FIG. 45, the message type “200 OK” in the start line of the SIP message and data similar to that in the BYE packet M32 in the message header. As the destination IP address and the source IP address of the IP header, the source address and the destination address of the BYE packet M32 are applied, respectively.

The 200 OK packet M33 is received by the address translator 35 and judged from the UDP port number as a packet for a SIP message (481). The address translator 35 encapsulates the 200 OK packet M33 in a manner similar to the IP (BYE) packet M29 and transfers the encapsulated packet as an IP (200 OK) packet M34 to the SIP-ALG 7 (482).

Upon receiving the IP (200 OK) packet M34, the SIP-ALG 7 translates the IP address of the IPv6 terminal 6B (User B) indicated in the contact header of the SIP message from the IPv6 address “22001:1::100” to the IPv4 address “138.90.0.2” (SIP payload translation: 438) and sends the resultant packet as an IP (200 OK) packet M35 shown in FIG. 46 back to the address translator 35 (484).

Upon receiving the IP (200 OK) packet M35, the address translator 35 deletes the encapsulation header in a manner similar to the reception of the IP (BYE) packet M31, translates the destination IP address and the source IP address from the IPv4 address to the IPv6 address with reference to the address translation table 330 (485), and transfers the resultant packet as a 200 OK packet M36 shown in FIG. 47 to the IPv4 terminal 5A (486).

After returning the IP (200 OK) packet M35 to the address translator 35, the SIP-ALG 7 generates a REQUEST packet M37 for releasing the virtual IP address which becomes unnecessary, and transmits the request packet M37 to the address translator 35 (490) As shown in FIG. 48, the REQUEST packet M37 designates message name indicative of a virtual address release request and the virtual IPv6 address “2002.8a55.1b0a” and the virtual IPv4 address “138.90.0.2” to be released in the payload (USER DATA)

Upon receiving the REQUEST packet M37, the address translator 35 deletes the entries EN3 and EN4 corresponding to the virtual address designated by the received packet from the address translation table 330, and registers the virtual IPv4 address “138.90.0.2” as a free address into the virtual address pool 340 (491). After that, the address translator 35 generates a RESPONSE packet M38 shown in FIG. 49 and transmits the packet to the SIP-ALG 7 (492). When the RESPONSE packet M38 is received, the SIP-ALG 7 releases the SIP payload conversion information (SIP entry) which became unnecessary due to the call disconnection (493).

FIG. 50 shows a flowchart of the packet transfer control program 110 to be executed by the address translator (protocol processor) 35 in order to realize the IP address translation and packet transfer.

In the packet transfer control program 110, a received packet is read out from the line side receiving buffer 31 or the internal switch side receiving buffer 34. If the reception route of the packet (111) is on the internal switch side, the internal header indicating internal routing information is removed from the received packet (112) Next, whether the received packet is for the SIP message or not is determined from the UDP destination port number of the received packet (113). If the received packet is one for the SIP message, the received packet is encapsulated with an encapsulation header having a destination IP address designating the SIP-ALG 7 (114) and step 123 is executed.

In the case where the received packet is not for the SIP message, the destination IP address is checked (115). In the case where the destination IP address is a virtual IP address, an entry corresponding to the destination IP address is retrieved from the address translation table 330 (118). If there is no corresponding entry in the address translation table 330, the program is terminated. In this case, the received packet is discarded as a result.

If there is an entry corresponding to the destination IP address (virtual IP address) in the address translation table, the validity bit 333A of the filter information is checked. When the validity bit 333A is “1”, whether the received packet satisfies the filter condition or not is determined by comparing the filter information with the header information of the received packet (121). If the received packet does not satisfy the filter conditions, the program is terminated. In this case, the received packet is also discarded.

When the validity bit 333A of the filter information is “0” or the received packet satisfies the filter conditions, the address of the IP header of the received packet is translated in accordance with the retrieved entry (122), and step 123 is executed.

In the case where the destination address is the address of the address translator itself, the UDP destination port number is checked (116). If the UDP destination port number has a value for tunnel communication (encapsulation packet communication) with the SIP-ALG 7, after deleting the encapsulation header from the received packet (117), the address translation table is searched (118).

In the case where the UDP destination port number has a value for SIP-ALG control message communication with the SIP-ALG 7, the SIP-ALG control message processing 130 which will be described in detail with reference to FIG. 51 is executed and, after that, step 123 is executed. When the destination address is other than a virtual address or the address of the address translator itself, step 123 is executed.

Instep 123, a transmission route of the received packet is checked. When the transmission route is in a direction of a line interface, that is, when the received packet is a packet read out from the internal switch side receiving buffer 34, the received packet is output to the line interface side transmission buffer 32 (127), and the program is terminated.

When the transmission route is in a direction of the internal switching unit, that is, when the received packet is a packet read out from the line side receiving buffer 31, a routing table is referred to and the output port number is determined (124). At this time, if the destination address of the received packet is an IPv4 address, the IPv4 address table 310 is used. In the case where the destination address is an IPv6 address, the IPv6 address table 310 is used. After that, an internal header including the output port number as internal routing information is added to the received packet (125), the received packet is output to the line side transmission buffer 32 (127), and the program is terminated.

FIG. 51 shows the details of the SIP-ALG control message processing 130.

In the SIP-ALG control message processing 130, the type of a message included in the received packet (hereinbelow, called a received message) is checked (131). If the received message is, for example, a virtual IPv6 address request message included in the REQUEST packet M4, a virtual IPv6 address is generated by combining the IPv4 address designated in the received message and a prefix of the IPv6 address assigned to the address translator (132), and a new entry indicative of the relation between the IPv4 address and the virtual IPv6 address is registered in the address translation table 330 (133) At this time, the filter information is in the provisional state. After that, a response packet to the request (for example, RESPONSE packet M4) is generated (134), and the SIP-ALG control message processing 130 is terminated.

In the case where the received message is, for example, a virtual IPv4 address request message included in the REQUEST packet M12, the virtual IPv4 address is obtained from the virtual address pool 330 (135), and a new entry indicative of the relation between the IPv6 address designated by the received message and the virtual IPv4 address is registered in the address translation table 330 (136). At this time, the filter information is in the provisional state. After that, a response packet to the request (for example, RESPONSE packet M13) is generated (137), and the SIP-ALG control message processing 130 is completed.

When the received message is, for example, a filter information registration request message included in the REQUEST packet M20, filter information designated by the received message is set formally in the address translation table 330 (138), a response packet to the request (for example, RESPONSE packet M21) is generated (139), and the SIP-ALG control message processing 130 is terminated.

When the received message is, for example, a virtual address release request message included in the REQUEST packet M37, an entry having the virtual IP address designated by the received message is deleted from the address translation table 330 (140), and the virtual IPv4 address which becomes unnecessary is released to the virtual address pool 330 (141). After that, a response packet to the request (for example, RESPONS packet M38) is generated (142), and the SIP-ALG control message processing 130 is terminated.

In the foregoing embodiment, the line Ln is used as a dedicate line for the SIP-ALG 7, and encapsulated packets for SIP messages and IP packet for SIP-ALG control messages are communicated via the line interface 11-n. However, the SIP-ALG 7 may be connected to any of the IPv6 networks and the IPv4 networks. Another configuration such that the SIP-ALG 7 is connected to the internal bus 15 as a part of the packet transfer apparatus may be also employed.

Although the IP address translation is executed by the protocol processing units on the IPv4 network side in the foregoing embodiment, the IP address translation of the invention may be also realized by the protocol processing units on the IPv6 network side. In this case, since transfer of control packets each including the SIP message to the SIP-ALG and assignment of a virtual address are performed by the protocol processing unit on the IPv6 network side, the protocol processing units on the IPv4 network side may merely transfer the control packets according to the destination IP address of the packets. It is therefore sufficient for the protocol processing units on the IPv4 network side to add an internal routing header without performing address translation and transfer the resultant packet to the internal switching unit even in the case where the destination is designated with a virtual IPv4 address. In this case, the packet transfer control program basically becomes a simplified program comprised of the steps 111, 112, and 123 to 127 in FIG. 50.

As obvious from the foregoing embodiments, according to the IP address translator of the invention, a virtual IPv6 address and a virtual IPv4 address are assigned to an IPv4 terminal and an IPv6 terminal, respectively, and registered as the address translation information in the address translation table in a session establishing process. Thus, packet communication via a virtual communication path between terminals of different protocol versions can be realized. Further, by storing filter information in association with the address translation information in the address conversion table, it is able to discard data packets illegally using the registered destination address.

What is claimed is:

1. An IP address translator located between an IPv4 network and an IPv6 network, comprising:
means for assigning, in a process of establishing a session between an IPv4 apparatus having an IPv4 address and an IPv6 apparatus having an IPv6 address, a virtual IPv6 address to the IPv4 apparatus and a virtual IPv4 address to the IPv6 apparatus;
an address translation table for storing a correspondence relation between the IPv4 address and the virtual IPv6 address, a correspondence relation between the IPv6 address and the virtual IPv4 address, and filter information in association with each of the virtual addresses; and
address translation processor for translating IP addresses of a data packet received from the IPv4 apparatus or the IPv6 apparatus in accordance with the address translation table,
wherein the address translation processor checks header information of each of data packets to be subjected to address translation on the basis of the filter information stored in the address translation table, discards a data packet which does not adapt to the filter information, and executes address translation on a data packet which adapts to the filter information.

2. The IP address translator according to claim 1, wherein filter information in association with the virtual IPv4 address specifies a source IPv6 address and a destination port number to be used in a data packet having the virtual IPv4 address as a destination address, and filter information in association with the virtual IPv6 address specifies a source IPv4 address and a destination port number to be used in a data packet having the virtual IPv6 address as a destination address.

3. The IP address translator according to claim 2, wherein the filter information specifies the type of a port to be designated in each data packet.

4. An IP address translator for translating IP addresses of each of data packets and session control packets transferred between an IPv4 network and an IPv6 network in accordance with an address translation table, comprising:
session control packet processing means for capturing a session control packet communicated between an IPv4 apparatus having an IPv4 address and an IPv6 apparatus having an IPv6 address, transferring the session control packet to a payload converter in a form of an encapsulated packet, translating when an encapsulated packet including a session control packet having been subjected to payload conversion is received from the payload converter, IP addresses of the session control packet extracted from the encapsulated packet, and transferring the resultant packet to a destination network;
address information managing means for assigning, in response to a request from the payload converter, a virtual IPv6 address or a virtual IPv4 address to an IPv4 address or an IPv6 address, storing address translation information indicative of a relation between the IPv4 address and the virtual IPv6 address and address translation information indicative of a relation between the IPv6 address and the virtual IPv4 address in association with filter information designated by the payload converter into the address translation table, and notifying the payload converter of the results of the virtual address assignment; and
address translation means for translating an IP address of a data packet received from each the IPv4 apparatus or the IPv6 apparatus in accordance with the address translation table,
wherein the address translation means checks header information of each of data packets to be subjected to address translation on the basis of the filter information stored in the address translation table, discards a data packet which does not adapt to the filter information, and executes address translation on a data packet which adapts to the filter information.

5. The IP address translator according to claim 4, wherein filter information in association with the virtual IPv4 address specifies a source IPv6 address and a port number to be used in a data packet having the virtual IPv4 address as a destination address, and filter information in association with the virtual IPv6 address specifies a source IPv4 address and a port number to be used in a data packet having the virtual IPv6 address as a destination address.

6. The IP address translator according to claim 4, wherein the virtual address managing means executes assignment of the virtual IPv6 address in response to a request of assigning a virtual IPv6 address to an IPv4 address issued from the payload converter, assignment of the virtual IPv4 address in response to a request of assigning a virtual IPv4 address to an IPv6 address issued from the payload converter, and deletes, in response to a virtual address release request issued from the payload converter, address translation information designated by the request from the address translation table.

7. The IP address translator according to claim 6, wherein the filter information in association with the virtual IPv4 address specifies a source IPv6 address and a port number to be used in a data packet having the virtual IPv4 address as a destination address, and filter information in association with the virtual IPv6 address specifies a source IPv4 address and a port number to be used in a data packet having the virtual IPv6 address as a destination address.

8. The IP address translator according to claim 4, wherein a payload of the session control packet includes a SIP (Session Initiation Protocol) message.

9. A packet transfer apparatus comprising a plurality of line interfaces, a plurality of protocol processing units each provided for each of the line interfaces, and a switching unit for switching packets among the plurality of protocol processing units,
wherein one of the line interfaces is connected to a payload converter, and at least one of protocol processing units which is accompanying a line interface connected to an IPv4 network or an IPv6 network is comprised of:
means for assigning, in a process of establishing a session between an IPv4 apparatus having an IPv4 address and an IPv6 apparatus having an IPv6 address, a virtual IPv6 address to the IPv4 apparatus and a virtual IPv4 address to the IPv6 apparatus;
an address translation table for storing a correspondence relation between the IPv4 address and the virtual IPv6 address, a correspondence relation between the IPv6 address and the virtual IPv4 address, and filter information in association with each of the virtual addresses; and
address translation processor for translating IP addresses of a data packet received from the IPv4 apparatus or the IPv6 apparatus in accordance with the address translation table,
the address translation processor having means for checking header information of each of data packets to be subjected to address translation on the basis of the filter information stored in the address translation table, discarding a data packet which does not adapt to the filter information, and executing address translation on a data packet which adapts to the filter information.

10. A packet transfer apparatus comprising a plurality of line interfaces, a plurality of protocol processing units each provided for each of the line interfaces, and a switching unit for switching packets among the plurality of protocol processing units,
wherein one of the line interfaces is connected to a payload converter, and at least one of the protocol processing units which is accompanying a line interface connected to an IPv4 network or an IPv6 network is comprised of:
session control packet processing means for capturing a session control packet communicated between an IPv4 apparatus having an IPv4 address and an IPv6 apparatus having an IPv6 address, transferring the session control packet to the payload converter in a form of an encapsulated packet, translating, when an encapsulated packet including a session control packet having been subjected to payload conversion is received from the payload converter, IP addresses of the session control packet extracted from the encapsulated packet, and transferring the resultant packet to a destination network;
address information managing means for assigning, in response to a request from the payload converter, a virtual IPv6 address or a virtual IPv4 address to an IPv4 address or an IPv6 address, storing address translation information indicative of a relation between the IPv4 address and the virtual IPv6 address and address translation information indicative of a relation between the IPv6 address and the virtual IPv4 address in association with filter information designated by the payload converter into an address translation table, and notifying the payload converter of the results of the virtual address assignment; and
address translation means for translating an IP address of a data packet received from the IPv4 apparatus or the IPv6 apparatus in accordance with the address translation table,
wherein the address translation means checks header information of each of data packets to be subjected to address translation on the basis of the filter information stored in the address translation table, discards a data packet which does not adapt to the filter information, and executes address translation on a data packet which adapts to the filter information.

11. The packet transfer apparatus according to claim 10, wherein filter information in association with the virtual IPv4 address specifies a source IPv6 address and a port number to be used in a data packet having the virtual IPv4 address as a destination address, and filter information in association with the virtual IPv6 address specifies a source IPv4 address and a port number to be used in a data packet having the virtual IPv6 address as a destination address.

12. The packet transfer apparatus according to claim 10, wherein the virtual address managing means executes assignment of the virtual IPv6 address in response to a request of assigning a virtual IPv6 address to an IPv4 address issued from the payload converter, assignment of the virtual IPv4 address in response to a request of assigning a virtual IPv4 address to an IPv6 address issued from the payload converter, and deletes, in response to a virtual address release request issued from the payload converter, address translation information designated by the request from the address translation table.

13. The packet transfer apparatus according to claim 12, wherein the filter information in association with the virtual IPv4 address specifies a source IPv6 address and a port number to be used in a data packet having the virtual IPv4 address as a destination address, and filter information in association with the virtual IPv6 address specifies a source IPv4 address and a port number to be used in a data packet having the virtual IPv6 address as a destination address.
